(19) United States
(12) Patent Application Publication
(10) Pub. No.: US 2006/0060464 A1
(43) Pub. Date: Mar. 23, 2006

(54) Plasma formed in a fluid

(76) Inventor: Chak Man Thomas Chang, Chapel Hill (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/513,703

(22) PCT Filed: May 8, 2003
(86) PCT No.: PCT/AU03/00549

§ 371 Date: Jul. 8, 2005

(30) Foreign Application Priority Data
May 8, 2002 (AU) PS 2203

(51) Int. Cl. H05F 3/00; B01J 19/08

(52) U.S. Cl. 204/164; 422/186

(57) ABSTRACT

A method and apparatus for generating plasma in a fluid. The fluid (3) is placed in a bath (2) having a pair of spaced electrodes (4, 6) forming a cathode and an anode. A stream of bubbles is introduced or generated within the fluid adjacent to the cathode. A potential difference is applied across the cathode and anode such that a glow discharge is formed in the bubble region and a plasma of ionized gas molecules is formed within the bubbles. The plasma may then be used in electrolysis, gas production, effluent treatment or sterilization, mineral extraction, production of nanoparticles or material enhancement. The method can be carried out at atmospheric pressure and room temperature. The electrodes may carry means to trap the bubbles in close proximity. Partitions may be present between the electrodes.

### INTRODUCTION

The invention relates to the provision and utilisation of a plasma formed in a fluid, and in particular to the provision and utility of a plasma formed within bubbles contained in an aqueous medium.

### BACKGROUND

Plasma is an electrically conductive gas containing highly reactive particles such as radicals, atoms, plasma electrons, ions and the like. For example plasma may be formed when atoms of a gas are excited to high energy levels whereby the gas atoms lose hold of some of their electrons and become ionised to produce plasma.

Thermal plasma including plasma arc is known. However plasma arc is associated with high power consumption, the rapid erosion of electrodes when used in electrolysis, the need for catalysts and high-energy loss due to the associated high temperatures.

Clearly therefore it would be advantageous if a non thermal plasma could be devised. This would enable the plasma to be used for a number of applications for which plasma is useful without the disadvantages associated with using a high temperature plasma arc.

### SUMMARY OF THE INVENTION

According to a first aspect of the present invention, there is provided a method for generating plasma in a fluid, comprising the steps of providing a fluid, introducing and/or generating one or more gas chambers or bubbles within the fluid, whereby the chambers or bubbles are contained by the fluid, and treating the fluid such that a plasma is generated within the chambers or bubbles.

The fluid may be a liquid that is contained within liquid containment means.

The applicant has discovered that a plasma can be generated relatively easily within bubbles within an aqueous medium. This plasma causes dissociation of molecules and/or atoms which can then be treated and/or reacted to obtain beneficial reaction products and/or molecules and/or atoms.

The liquid containment means may be open to the atmosphere and the process may therefore be carried out at substantially atmospheric pressure. Alternatively the containment means may be contained within a sealed reaction chamber, e.g. under partial vacuum. This reduction in pressure can reduce the energy required to achieve a glow discharge within the bubbles passing over a cathode.

Importantly the process is not required to be carried out in a vacuum.

The plasma may be formed, for example, by applying a potential difference across electrodes that are immersed in the liquid.

Upon passing electricity of sufficient potential between two electrodes, the dielectric barrier associated with the bubble/chamber surface breaks down, with the accompanying formation of a glow discharge and plasma inside the gas bubbles or chambers. This enables plasma formation to be effected at very low voltages, current, temperature and pressure, as compared with known methods of plasma formation.

For example, typical voltages and currents associated with plasma arc are in the region of 5 KV and 200 A respectively, whilst in the present invention, a plasma may be provided with a voltage as low as 350 V and a current as low as 50 mA.

The formation of a glow discharge region adjacent said one electrode is caused by a dielectric breakdown in the bubbles surrounding the electrode. The bubbles have a low electrical conductivity and as a result there is a large voltage drop between the electrodes across this bubble region. This voltage drop accounts for a large portion of the overall voltage drop across the electrodes. The plasma is generated within the bubbles contained within the electrolyte. The liquid electrolyte acts as containment for the plasma within the bubbles.

When plasma discharge occurs, any water vapor inside the bubbles will experience plasma dissociation whereby H+, OH−, O−, H, H3, and other oxidative, reductive and radicals species are formed. The formation of charged plasma species will of course also depend on the chemical composition of the electrolyte.

In the present invention, the voltage needed for plasma generation is much lower than plasma glow discharge generated under gas only conditions. For example experiments have demonstrated that plasma begins to occur at voltages as low as 350V and the maximum voltage required should not exceed 3000V. This requirement is based on a current density of 1 to 3 Amp/cm² which can be achieved at the point of discharge whereby the current input ranges from 50 to about 900 mA.

Plasma can be created, according to the present invention, in a steady manner with a low voltage and current supply, which leads to an economy in power consumption.

The bubbles may contain precursor materials originating in the fluid, which is preferably a liquid, more preferably being an aqueous electrolyte. This material may have been transferred from the liquid to the bubbles by diffusion or evaporation.

Alternatively the precursor may be introduced directly into the bubbles from outside the system.

The step of generating bubbles within the aqueous medium may be accomplished by one or more of the following: electrolysis, ebullition, ultrasonic cavitations, entrainment, sparging, chemical reaction, dissociation by electrons and ion collisions or local heating or ebullition, hydraulic impingement, ultrasonic waves, laser heating, or electrochemical reaction, electrode heating, releasing of trapped gases in the liquid, and externally introduced gases or a combination thereof.

Electrolysis bubbles may be generated by the electrode as a result of the potential differences applied thereacross, e.g. hydrogen bubbles liberated by the cathode or oxygen bubbles liberated by the anode. Ebullition bubbles may be generated by electrical heating in the region of the electrodes. The bubbles may be generated by direct electrical heating or by heating in proximity to the electrode by a moving wire or grid. Microwave heating and heating using lasers may also be used to generate ebullition bubbles.

Cavitation bubbles may be generated by using an ultrasonic bubble generator or a jet of fluid or a jet of a mixture of gas and liquid injected into the electrolyte in proximity to the electrode. Cavitation bubbles may also be generated by hydrodynamic flow of the electrolyte in proximity to the electrode. Sparging of gas in proximity to the electrode may also be used to generate bubbles.

Bubbles may also be generated by a chemical reaction which evolves gas as a reaction product. Typically such reactions involve thermal decomposition of compounds in the electrolyte or acid based reactions in the electrolyte. Bubbles may also be formed in the electrolyte by adding a frother thereto.

Typically the generation of bubbles forms a bubble sheath around said one electrode. The bubble sheath may have a thickness of from a few nanometres to say 50 millimetres. Typically the bubble sheath may have a thickness of 1 to 5 mm. Further it should be understood that the bubbles may not be homogeneous throughout the sheath.

Gas or vapour formed external to the container may be pumped or blown into the aqueous medium in proximity to the cathode.

Thus the composition of the plasma that is generated within the bubbles may be tailored to suit the application to which the plasma is being put and the bubbles may either be generated within the liquid from components within the liquid or introduced into the liquid from outside the containment means.

The bubbles can assume various sizes and shapes including a sheet form air gap or air pocket covering shrouding the electrodes or spread across the liquid media in micro bubbles.

Liquid foam may also be considered to be bubbles or gas chambers for the purposes of the present invention. This is a highly concentrated dispersion of gas within a continuous interconnecting thin film of liquid. The gas volume can reach up to 80% of a contained area. Gas generated within or introduced to the reactor externally can also be encapsulated within a foaming agent to enable it to undergo plasma discharge treatment.

Gases trapped inside a thick liquid mist in a confined space are also considered to be gas containing bubbles, which contain the gases, and liquid vapors that provide the condition for generation of non-thermal plasma. The liquid may contribute one or more source materials for dissociation during the plasma discharge.

In practise, gas bubbles evolving near and shrouding an electrode in an electrolysis process create a dielectric barrier which prevents and slows down the flow of current. At the same time the dissolved gas or micro bubbles spread and diffuse in the liquid volume thereby creating a high percentage of void fractions (micro gas bubbles) which in turn increase the electric resistance whereby the voltage across the liquid media is raised. When the voltage has increased sufficiently, gas trapped inside the bubbles undergoes non-equilibrium plasma transformation. At this point, di-electric breakdown occurs enabling resumption of current flow through the bubbles sheath or air pocket layer.

Any water molecules and atoms lining the gas and liquid interface of a bubble shell will also be subjected to the influence of the plasma to produce H+ and OH− and other radical species. Some of these neutralized atoms and molecules will transpose into the gas bubbles as additional gas that increases the size of the bubble. As such the bubbles pick up more liquid vapors before a next succession of plasma discharge. Such a cycle of such repetitive discharge can take place in a fraction of a second to several seconds depending on the make up of the electrode and reactor.

The step of generating bubbles within the aqueous medium may include adding a foaming agent to the aqueous medium such that bubbles are formed within foam. The foam bubbles are confined by aqueous media that is electrically conductive. The foam bubbles can vary widely in size down to a fraction of a millimetre.

The step of generating bubbles may include forming an aerosol mist. The gas within the aerosol mist broadly defines bubbles in the sense that there are volumes of gas between liquid droplets. These bubbles in the form of spaces between liquid drops function in a similar way to conventional bubbles within a liquid and a plasma is formed in this gas in the same way as described above.

An advantage of foam and aerosol mist is that it provides for good mixing of gaseous components within the mist and foam. The plasma is generated in the bubbles of the foam and aerosol mist in the same way that they are formed in an aqueous liquid, e.g. by passing electrical current between spaced electrodes within the foam or mist.

The step of forming a glow discharge in the bubble region may be achieved by increasing the potential difference across the electrodes above a certain threshold point.

The formation of a glow discharge and generation of plasma within the bubbles may be assisted by a pulsed or steady power supply, a magnetron field, ultrasonic radiation, a hot filament capable of electron emission, laser radiation, radio radiation or microwave radiation. The energy requirements may also be assisted by a combination of any two or more of the above features. These factors may have the effect of lowering the energy input required to reach the threshold potential difference at which glow discharge is formed.

In conventional electrochemical processes bubbles are regarded as undesirable. As a result concerted efforts are made to avoid the generation of bubbles during the operation of electrochemical cells. By contrast the process of the current invention deliberately fosters the formation of bubbles and utilises bubbles in proximity to the electrode as an essential feature of the invention. The bubble sheath surrounding the electrode is essential to establishing a plasma region which then gives rise to the plasma deposition on the article.

Thus the plasma is formed within bubbles and the molecules and/or atoms that are ionised are surrounded by liquid which effebtively provides a containment structure within which the plasma is contained. The liquid in turn generally opens to the atmosphere.

Plasma glow discharge can be fairly easily accomplished within the cell because the sheath of bubbles has the effect of causing a substantial proportion of the voltage drop to occur across the bubble sheath. It is concentrated in this area rather than a linear drop across the electrode space. This provides the driving force to generate plasma glow discharge and from there deposition of the ionic species.

The electrical charge is preferably applied in pulses, since this enables plasma production at lower voltages.

The fluid is preferably a liquid electrolyte, for example an aqueous medium, whereby in one preferred embodiment, the medium is water.

The electrolyte may comprise a carrier liquid and /or a source or precursor of the material to be ionised by the plasma.

When the liquid is water, charged plasma particles include species such as OH radicals, O− and H+, —OH, O2 and O3, which will react with the surrounding liquid.

Distilled water is known to be dielectric and non-conductive. It is however when water contains impurities such as dissolved minerals, salts and colloids of particles, whereby water becomes conductive, that ionisation and electrolysis can occur.

The method may further include adding an additive, such as an acidic or alkaline conductivity enhancing agent, to the aqueous medium to enhance this electrical conductivity such as organic salts or inorganic salts, e.g. KCl, MgCl2, NaOH, Na2CO3, K2CO3, H2SO4, HCl.

The method may include adding a surfactant to the aqueous medium for lowering the surface tension of the medium and enhancing the formation of bubbles, e.g. to stabilise bubble formation.

The electrolyte may further include additives in the form of catalysts for increasing the reaction of molecules and/or atoms produced in the plasma, additives for assisting the formation of bubbles, and additives for buffering the pH.

The method may further include cooling the electrolyte to remove excess heat generated by the plasma reaction and regulating the concentration of one or more components within the electrolyte.

The cooling may comprise drawing electrolyte from the bath pumping it through a heat exchanger, and then returning it to the bath.

Plasma creation, according to the present invention can be effected in the absence of extreme conditions, for example plasma according to the present invention may be provide under atmospheric pressure and at room temperature.

During plasma production according to the present invention, a shroud of bubbles preferably builds up and smothers around at least one of the electrodes, whereby electrical charge builds up in the bubble shroud thereby creating a dielectric barrier which impedes current flow, whereby electrical resistance in the fluid medium builds up so that voltage through the medium is raised to a degree such that gas within the bubbles is excited to an energy level at which a plasma is produced.

The method according to the present invention preferably comprises the further step of exposing the plasma to a material, which on contact with the plasma undergoes a chemical and/or physical change.

For example the plasma can be used to cause dissociation of toxic compounds and then break down the compounds and/or cause them to undergo reactions leading to innocuous reaction products

The plasma produced according to the present invention, which will be referred to as ‘under liquid’ plasma has the same physical and chemical properties as plasma produced according to known methods and accordingly also has the utility of such plasma.

The under liquid plasma according to the present invention can create an active catalytic condition which facilitates gas and liquid interaction. As such, the plasma according to the present invention, may promote any reaction which takes place in a liquid medium, for example chemical reactions, the production of pharmaceuticals, production of nano-particles, the extractionn of metals from liquid, low temperature sterilization of liquid food, use in paper industries to decontaminate the effluent discharge, fragmentation or de-lignifications of cellulose; the removal of odor from discharging liquid in the food industries, and the treatment of fluid effluent. Material may be chemically modified by means comprising one or more of the following: ionisation, reduction, oxidation, association, dissociation, free radical addition/removal, whereby, optionally, following chemical modification, the material is removed.

The invention may be used to tackle existing problems. For example, water that has been used in industrial processes or used in some other way has to be treated to remove harmful components before it is returned to ground water. This is typically achieved by reacting the harmful components with other chemical components introduced to the water to form relatively harmless products. Many undesirable components are treated fairly effectively in this way.

However some harmful components within water are not capable of being treated in this fashion. This poses a problem as these harmful components, e.g. contaminants, need to be removed from the water before it is returned to ground water. One known way of treating some of these components is to use an electric arc process to break down these toxic chemicals. However an electric arc process requires a substantial amount of energy to arc between electrodes within the liquid and is therefore costly. In addition the number of chemicals that are able to be treated in this way is limited. A further limitation of these processes is that they often cause rapid consumption and degradation of electrode material. Applicant believes that this water could be better treated by the method of this invention.

Moreover the electric arc method of providing plasma applies a high voltage across closely spaced electrodes causing the break down and ionisation of molecules, and then a surge of electrical current between the electrodes.

Further many metals or mineral occur naturally in the ground in the form of ores as mineral oxides. The minerals need to be reduced to useful minerals. Typically the reduction is carried out using pyrometallurgical techniques, e.g. such as are used in electric arc furnaces. These treatments are very aggressive and utilise enormous amounts of electrical energy. Clearly it would be advantageous if a simpler more streamlined and more energy efficient method of reducing a mineral oxide to a mineral could be devised. Applicant believes that this could be done by the method of this invention.

Yet further the generation of electrical energy with fuel cells is seen as an exciting new area of technology. Such fuel cells utilise hydrogen as a fuel. Accordingly a relatively inexpensive source of this hydrogen as a fuel is required. Currently hydrogen is produced by solar cells. However the present invention could be used to provide such a source of hydrogen.

In one form of the current invention, the undesirable compounds may be deposited on a said electrode, e.g. the cathode, as a layer or coating. The compound can then be removed from the liquid by simply removing it from the aqueous medium.

In another form, the undesirable component can be reacted with a chemical compound, e.g. within the plasma, to form a solid compound, e.g. a salt in the form of a precipitate, that settles out of the aqueous medium and can then be removed from the aqueous medium.

Typically the undesirable component will be toxic to animals or harmful to the environment. However components that are undesirable in other ways are also included within the scope of the invention.

Applicant envisages that this will be particularly useful for the removal of harmful heavy metals from waste water. It will probably also be useful for the treatment of contaminated gases. Such gases will be introduced to the aqueous medium in such a way that they form part of the bubbles passing over the cathode and then be treated as described above.

Another example is the extraction of a mineral, e.g. a metal, from its metal oxide, the method including: dissolving the mineral oxide in an aqueous medium and then subjecting it to the method described above according to the first aspect of the invention whereby a plasma is generated within bubbles passing over the cathode, and the plasma reduces the mineral oxide to the mineral per se.

The ozone that is formed in the plasma can then be reacted with hydrogen to form an innocuous compound such as water. The reduced mineral that is formed in the plasma, e.g. a metal, may be deposited on the cathode or else may be precipitated out as a solid in the containment means.

In the case of water, hydrogen and oxygen produced, travel to the anode and cathode and are preferably then removed. As such, the process according to the present invention is an economical, simple and effective way of producing hydrogen.

The hydrogen produced in this fashion may be used as fuel, e.g. in fuel cells for the generation of electricity. Applicant believes that hydrogen can be produced relatively inexpensively in this fashion. Fuel cell technology is currently receiving an increased level of acceptance looking for a cheap source of the supply of hydrogen.

According to another aspect of the present invention there is provided the use of this ‘under liquid’ plasma in one or more of the following: chemical and/or physical treatments of matter, electrolysis, gas production, in particular hydrogen gas production; water, fluid and/or effluent treatment; mineral extraction; sterilization of drinking water and/or liquid food, production of nano-particles, the enhancement of material chemical and physical properties.

According to a further related aspect of the present invention there is provided an apparatus for providing a plasma comprising; a container in which a plasma is provideable, bubble trapping means, arranged within the container, for trapping gas bubbles at a predetermined location in the container and, plasma creation means, in association with the container, for creating a plasma from the gas within the bubbles.

The plasma creation means preferably comprise electrical discharge means which most preferably comprise a cathode and/or an anode.

The apparatus, in one preferred embodiment being an electrolysis cell, further preferably comprises bubble introduction and/or generating means, for introducing and/or generating bubbles in the container.

Furthermore the apparatus preferably comprises one or more of the following: enhancing means for enhancing plasma formation and one or more non-conductive partitions arranged between the electrodes, whereby the enhancing means preferably comprise bubble trapping means most preferably associated with the electrodes and wherein the enhancing means may also comprise current concentrating means for concentrating the electrical current at a predetermined position in the container which can take the form of one or more channels arranged through one or more of the electrodes.

The electrodes may take any suitable form, for example the electrodes may be so profiled as to entrap/attract bubbles, in order to help gas bubbles being created or introduced to the discharging electrode to form a dielectric barrier by which the voltage can be raised whereby a suitable current density is provided directly by high input of current or passively created by a current concentrating arrangement, for example, by conducting the current through small holes on the electrodes or by reducing the discharge surface area of the electrodes whereby in the latter case, the electrodes may take the form of pins, wires, rods and the like.

For example, the cathode may be formed by a hollow tube with perforated holes therein, e.g. small perforated holes. The holes allow bubbles introduced into the tube to pass out of the tube into the aqueous medium. Alternatively a cathode may be made of wire mesh or have a roughened surface, e.g. to encourage the attachment of bubbles thereto to slow down the movement of the bubbles.

In one embodiment there are a plurality of cathodes spaced apart from each other and in parallel with each other, and a single rod-like anode, e.g. centrally positioned relative to the cathode.

The other electrode (non discharging) preferably has a larger surface area such than the discharging electrode.

The discharging electrode can either be cathode or anode depending on the application necessity.

In an experimental reactor the separating membrane, non-conductive partition, was nylon cleaning cloth having a tight matrix 0.5 mm thick. This semi-permeable membrane is capable of resisting the passage of oxygen and hydrogen ions therethrough in the aqueous medium, intermediate the anodes and cathodes thereby to maintain separation of oxygen and hydrogen produced in the plasma.

Most preferably, the apparatus according to the present invention is an electrolytic cell.

A known problem with carrying out electrolysis is that any gas/bubble build up in the electrolytic cell creates a barrier to the flow of current through the electrolyte, thereby impeding electrolysis, which increase in resistance in turn forces the required voltage up. As such, electrolytic cells require a great deal of energy and are often very large in order to effect dispersion of such gas/bubbles. However the present invention actively promotes such bubble build up, in order to effect plasma creation which the inventors have shown is effective in carrying out electrolysis.

### DETAILED DESCRIPTION OF PREFERRED EMBODIMENTS OF THE INVENTION

A plasma formed in a fluid in accordance with this invention may manifest itself in a variety of forms. It will be convenient to hereinafter provide a detailed description of embodiments of the invention with reference to the accompanying drawings. The purpose of providing this detailed description is to instruct persons having an interest in the subject matter of the invention how to put the invention into practice. It is to be clearly understood however that the specific nature of this detailed description does not supersede the generality of the preceding statements. In the drawings:

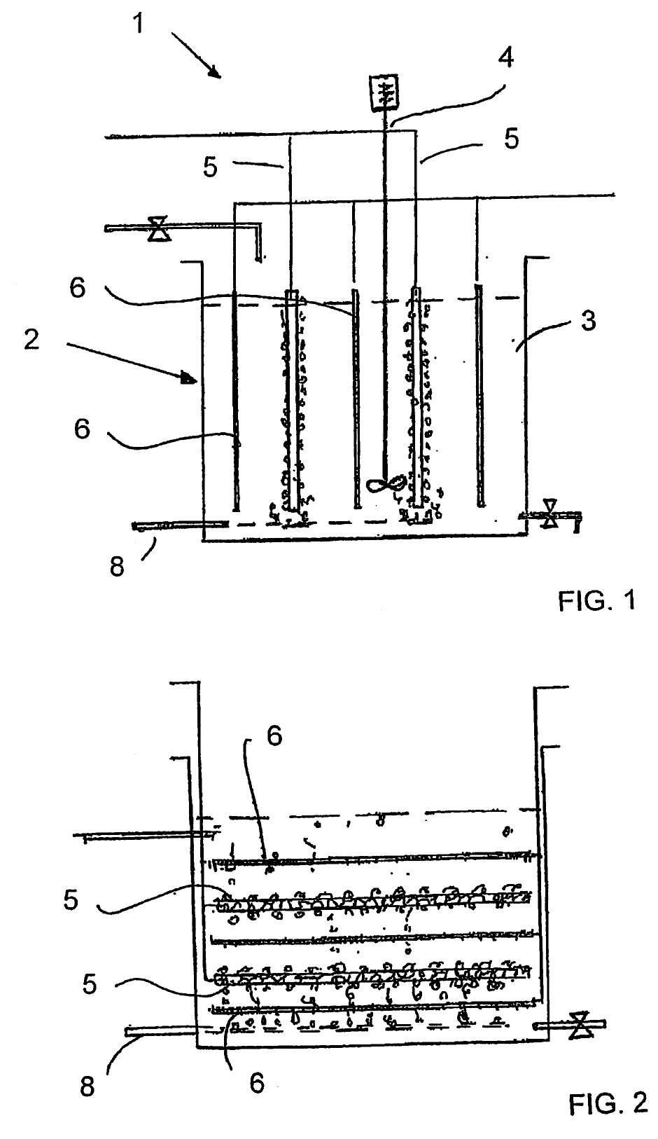

FIG. 1 is a schematic sectional front view of apparatus for carrying out a method in accordance with the invention;

FIG. 2 is a schematic sectional front view of a variation on the apparatus of FIG. 1;

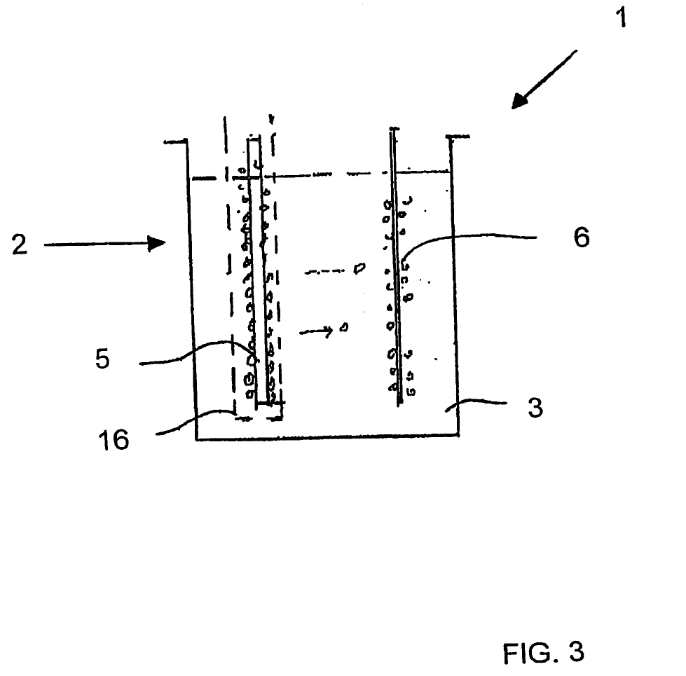

FIG. 3 is a schematic sectional front view of an apparatus in accordance with the invention suitable for producing hydrogen gas;

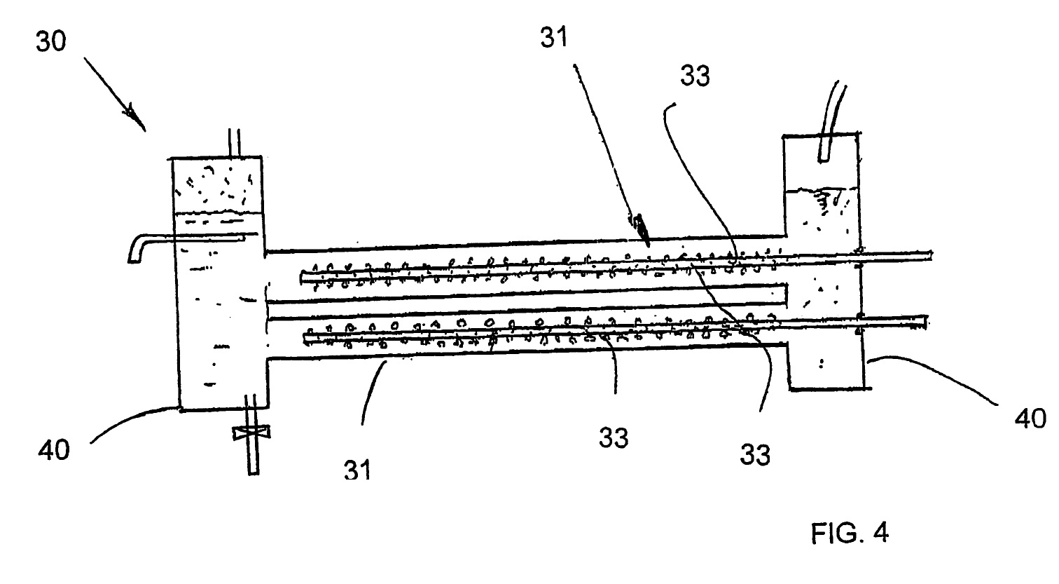

FIG. 4 is a schematic sectional front view of a tubular reactor carrying out a method in accordance with another embodiment of the invention;

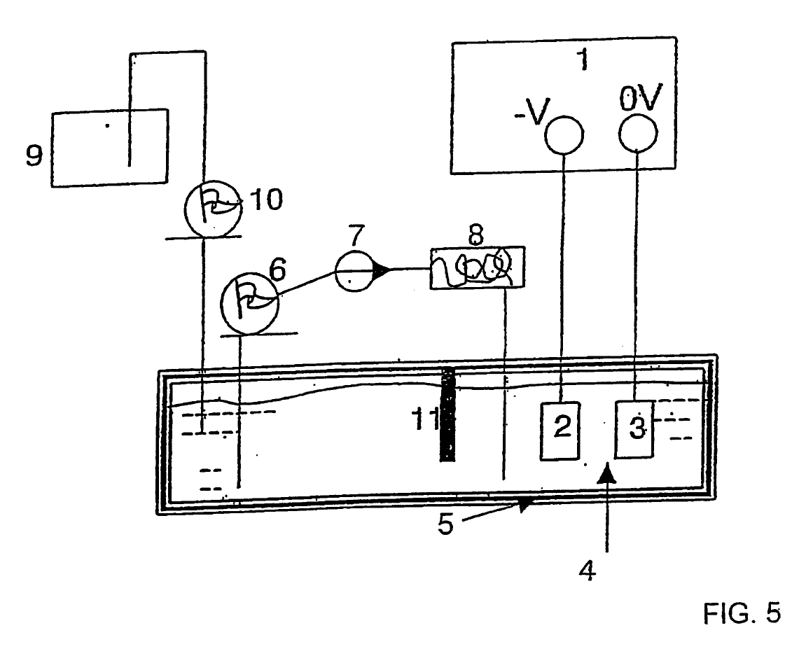

FIG. 5 is a schematic flow sheet of apparatus in the form of a cell for carrying out the invention;

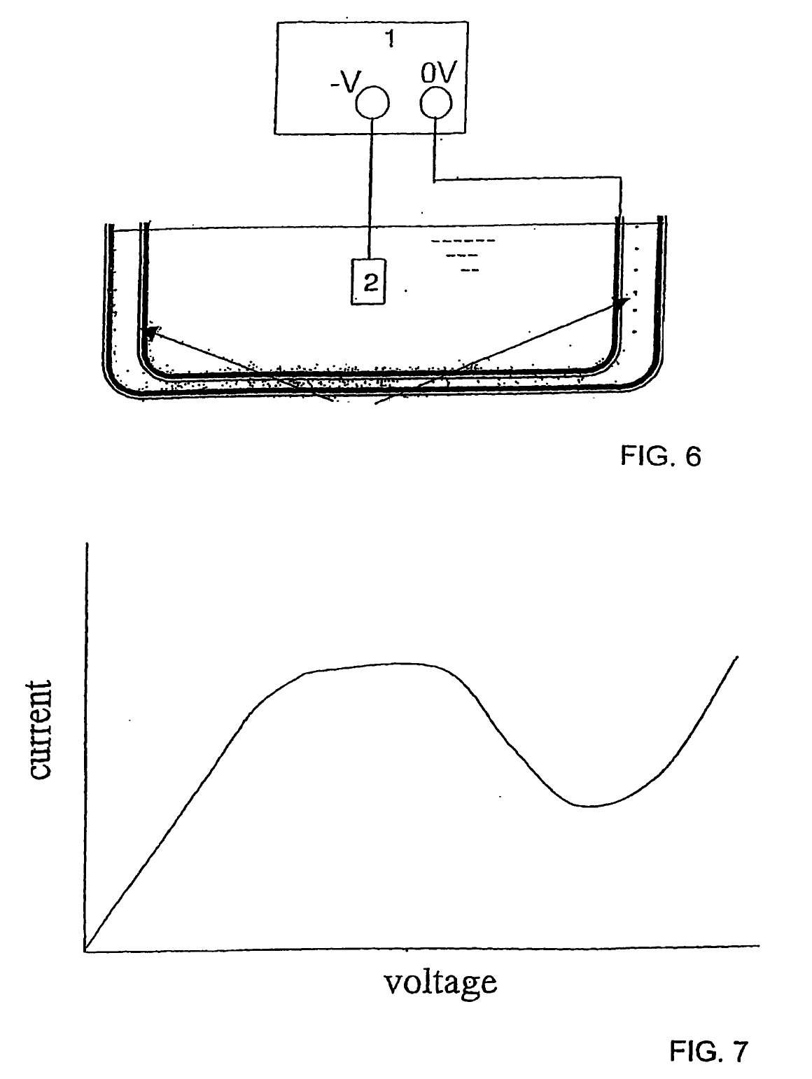

FIG. 6 is a schematic view of a bath for the cell of FIG. 5 having an ultrasonic generator for generating bubbles;

FIG. 7 is a schematic graph of current against voltage in an electrolytic cell;

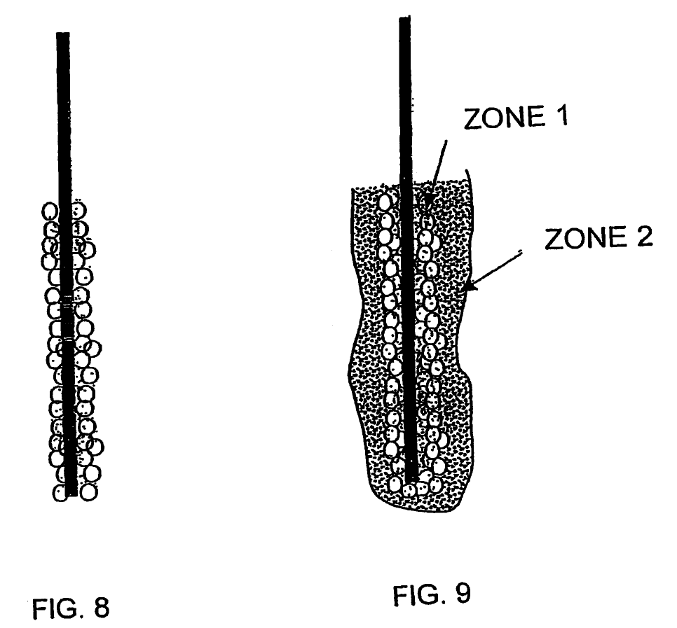

FIG. 8 shows the initial formation of a bubble sheath around the cathode due to the application of voltage across the electrodes;

FIG. 9 shows the bubble sheath around the cathode during stable glow discharge within the cell; and

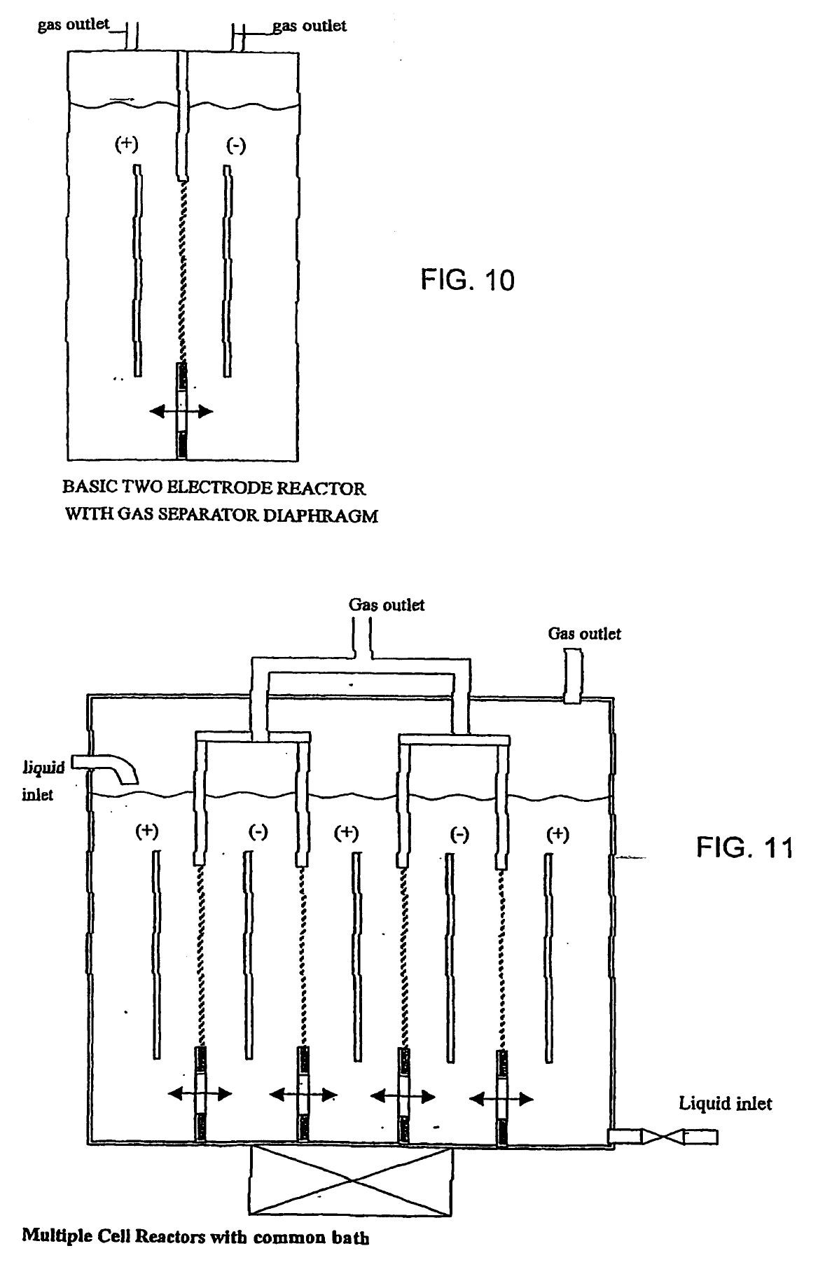

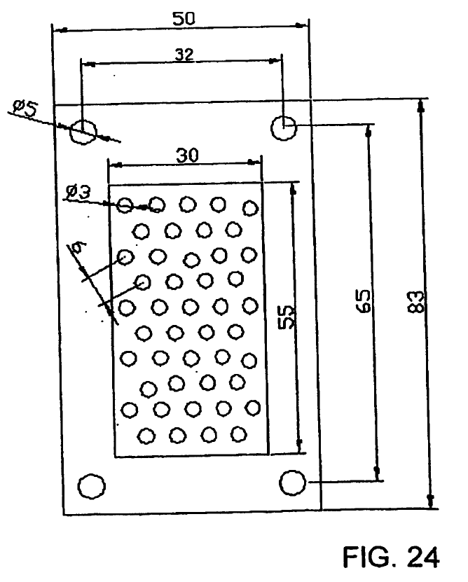

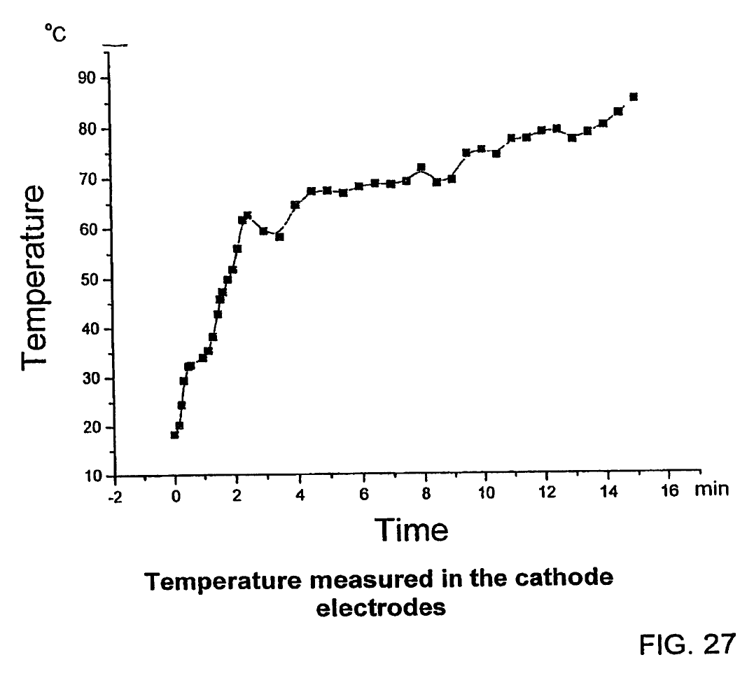

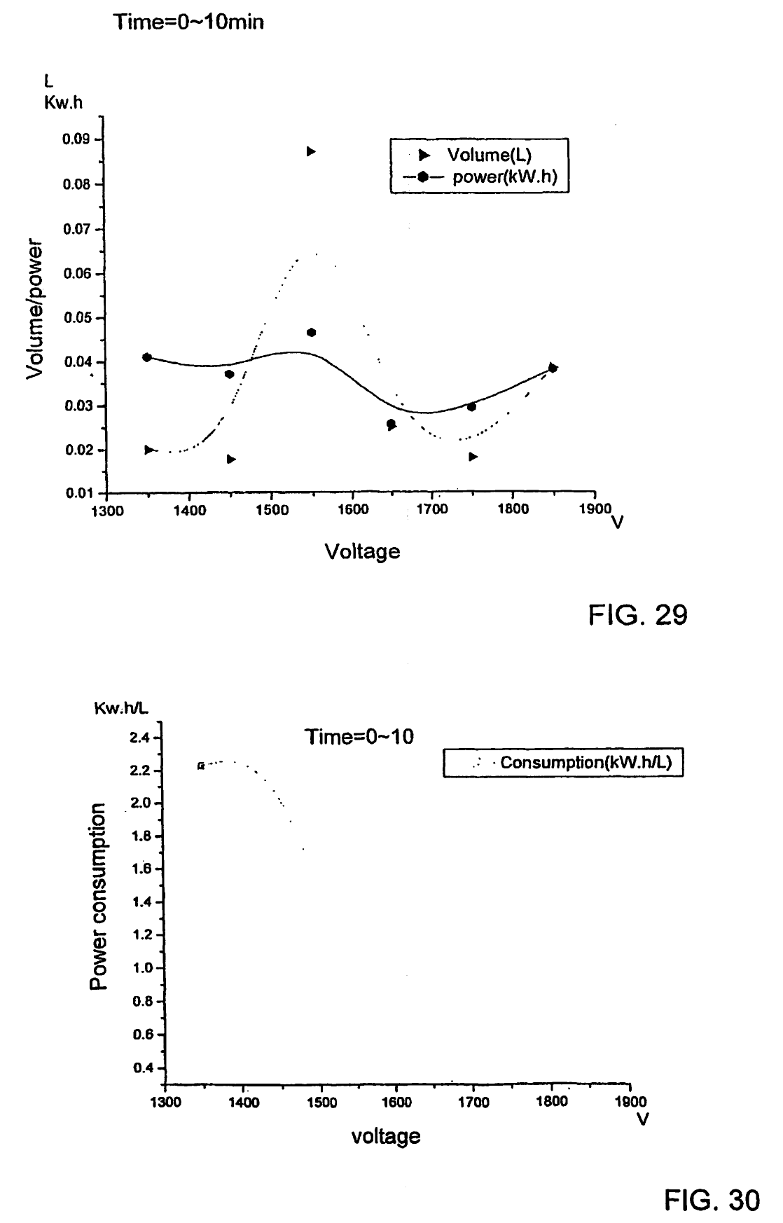

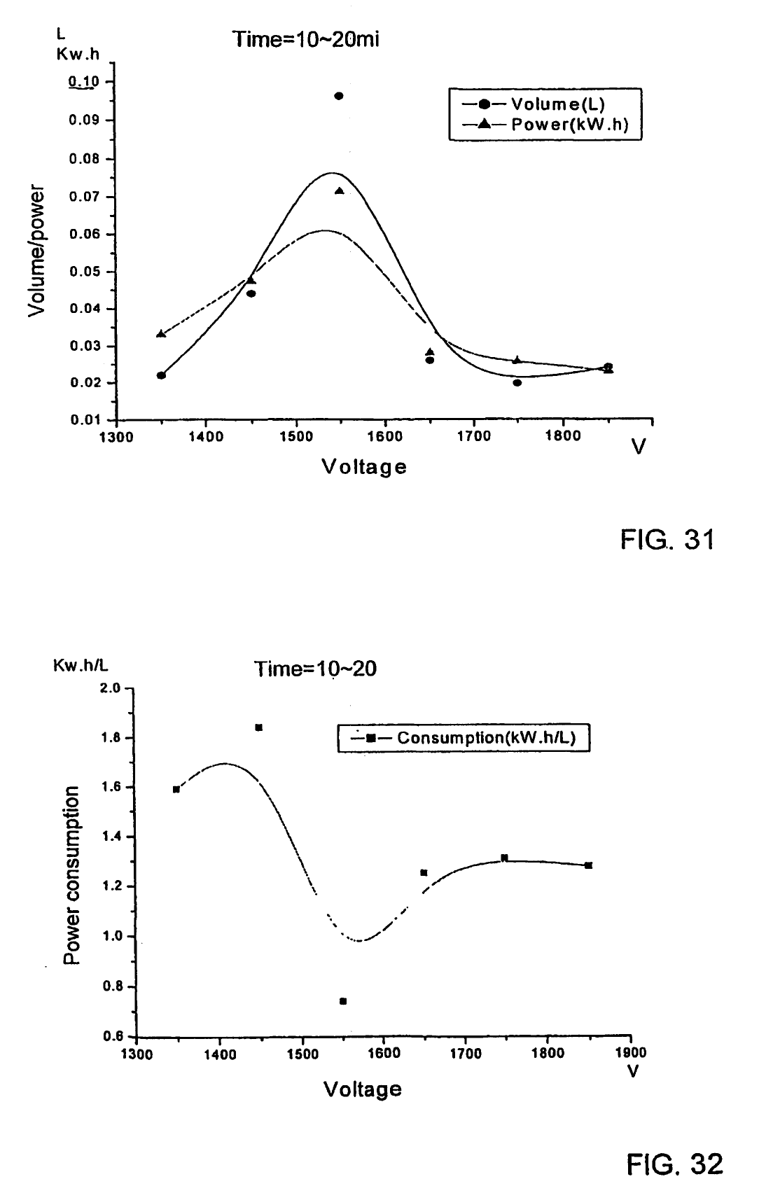

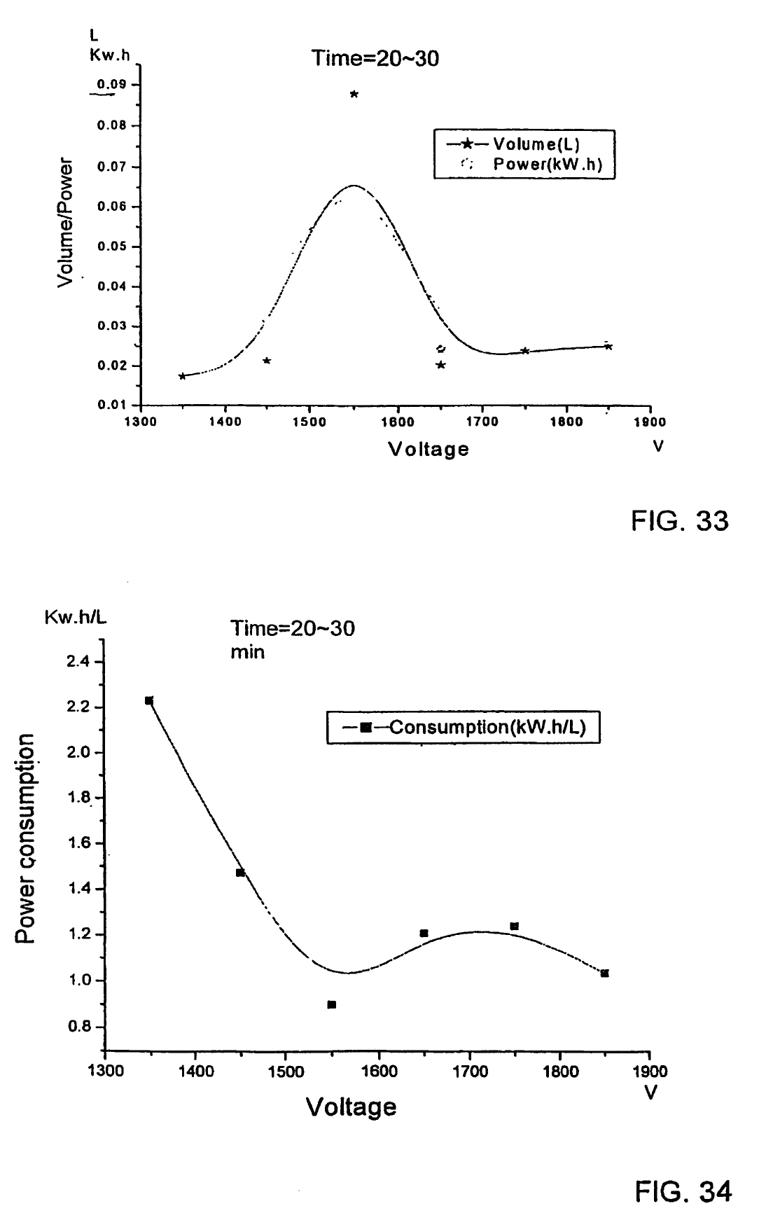

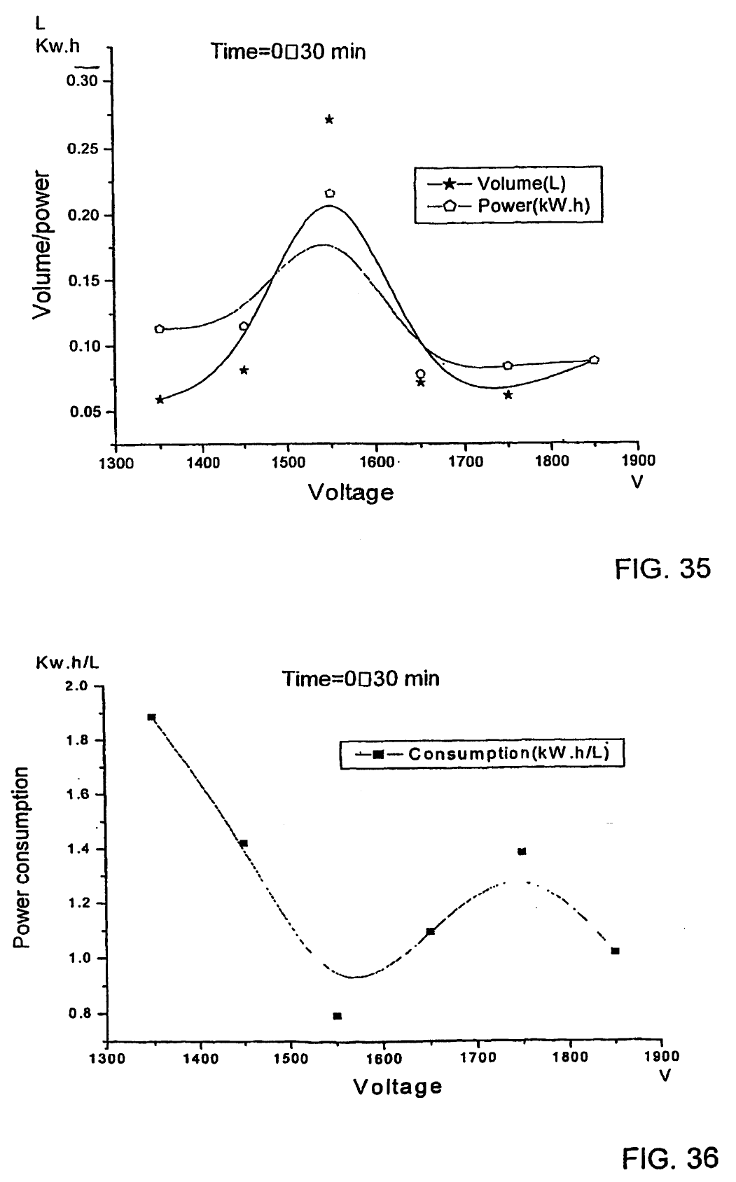

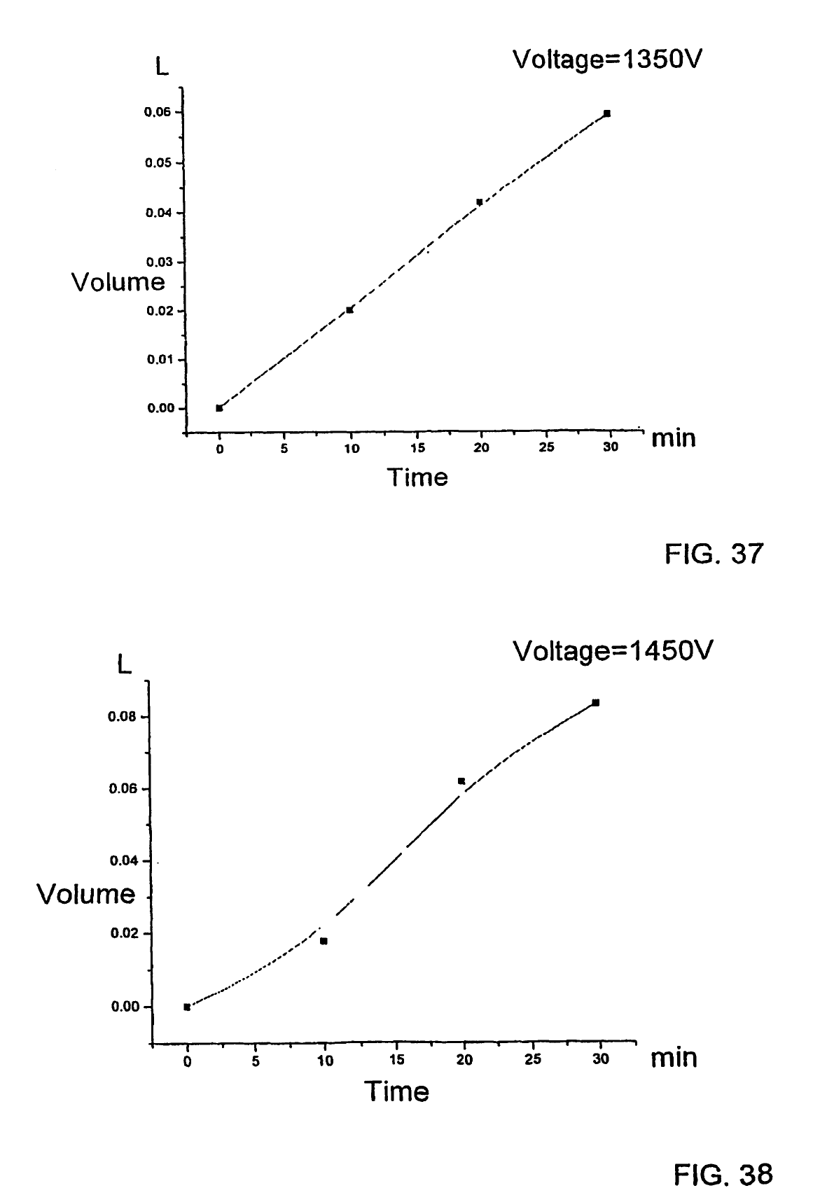

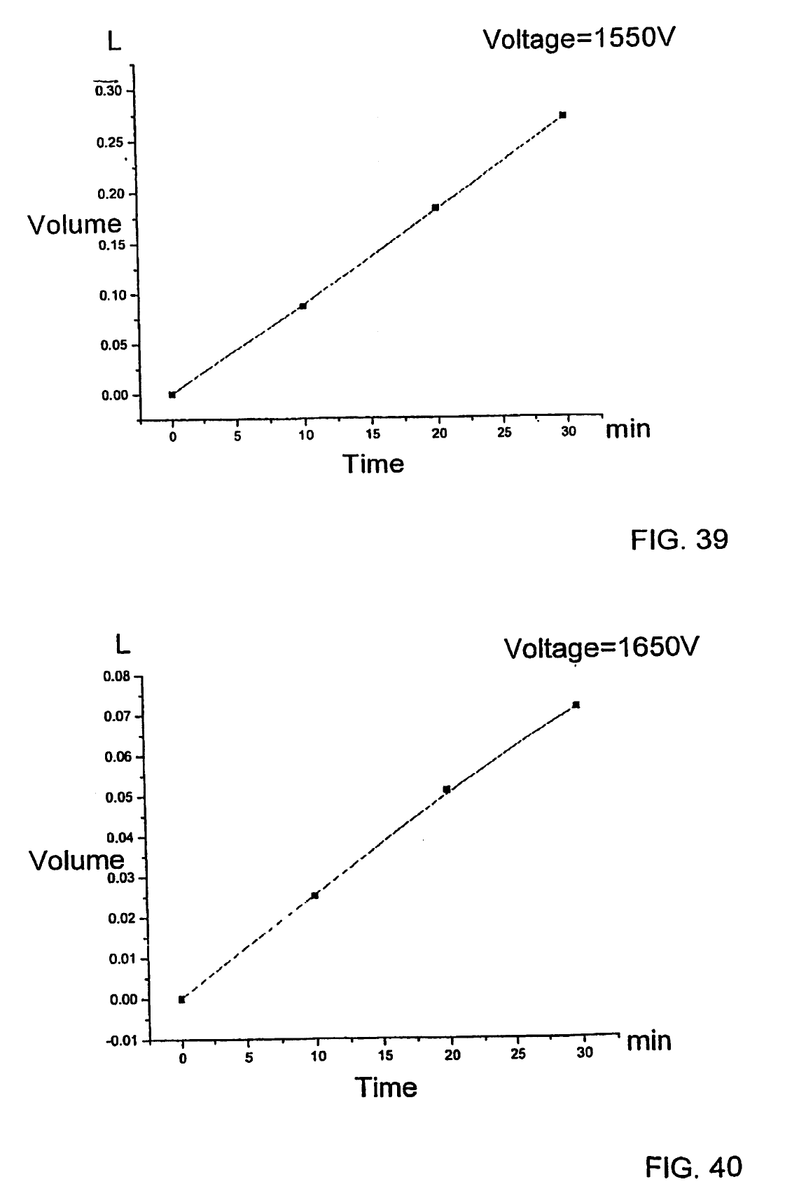

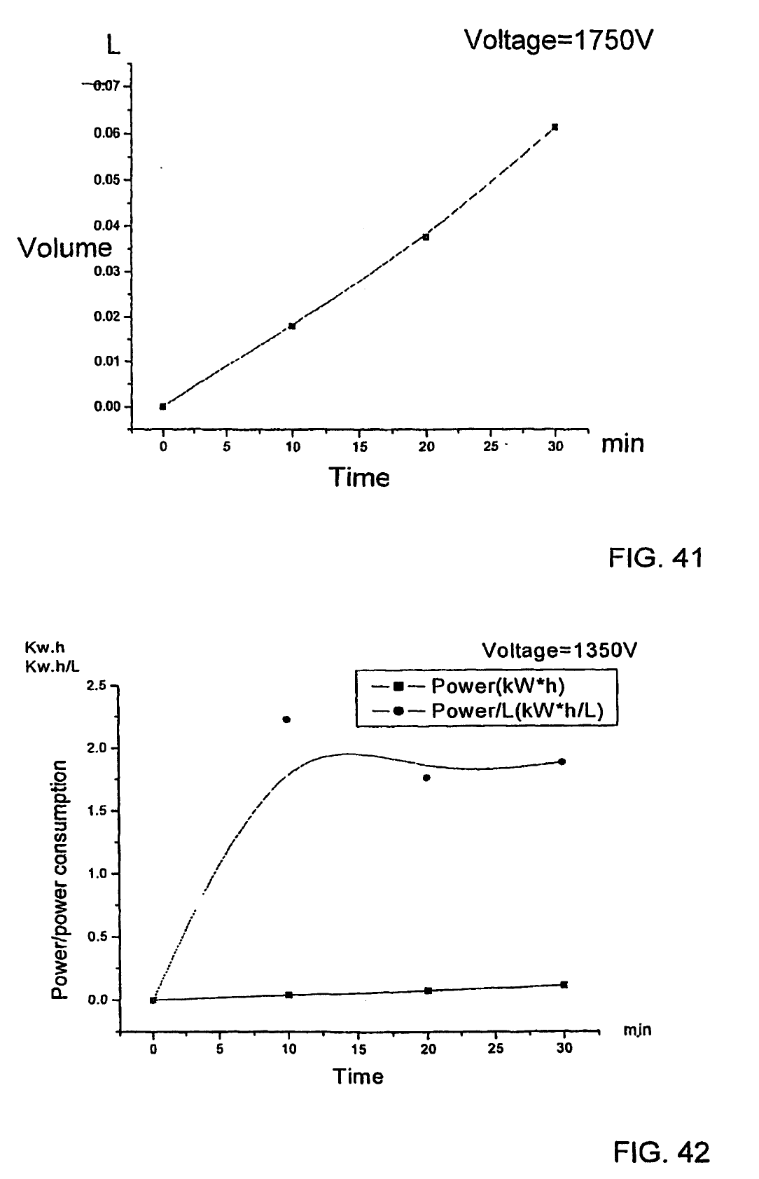

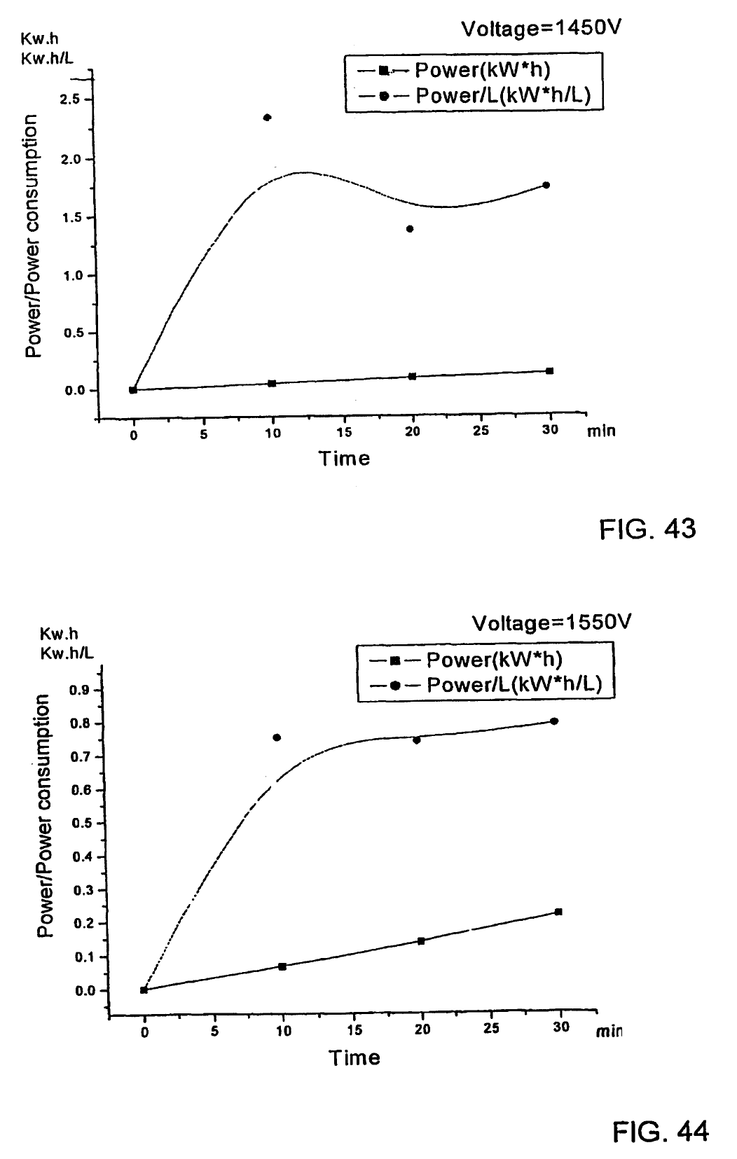

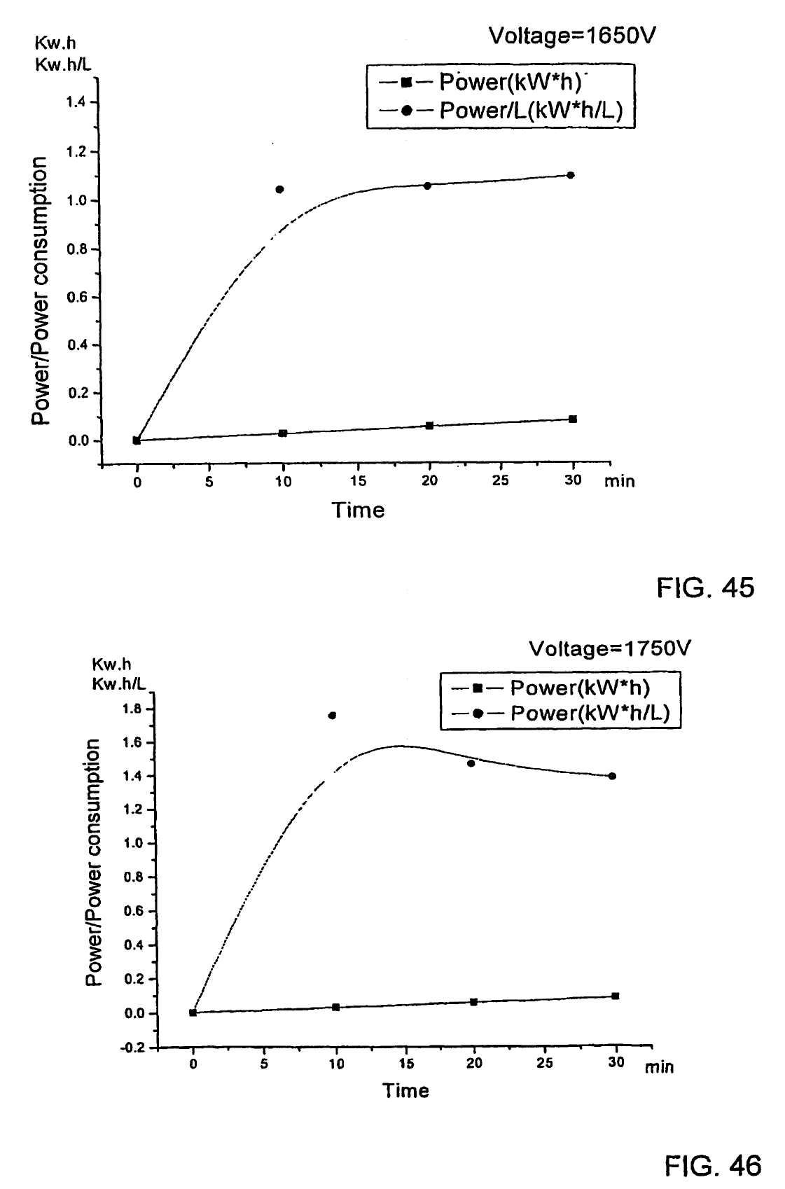

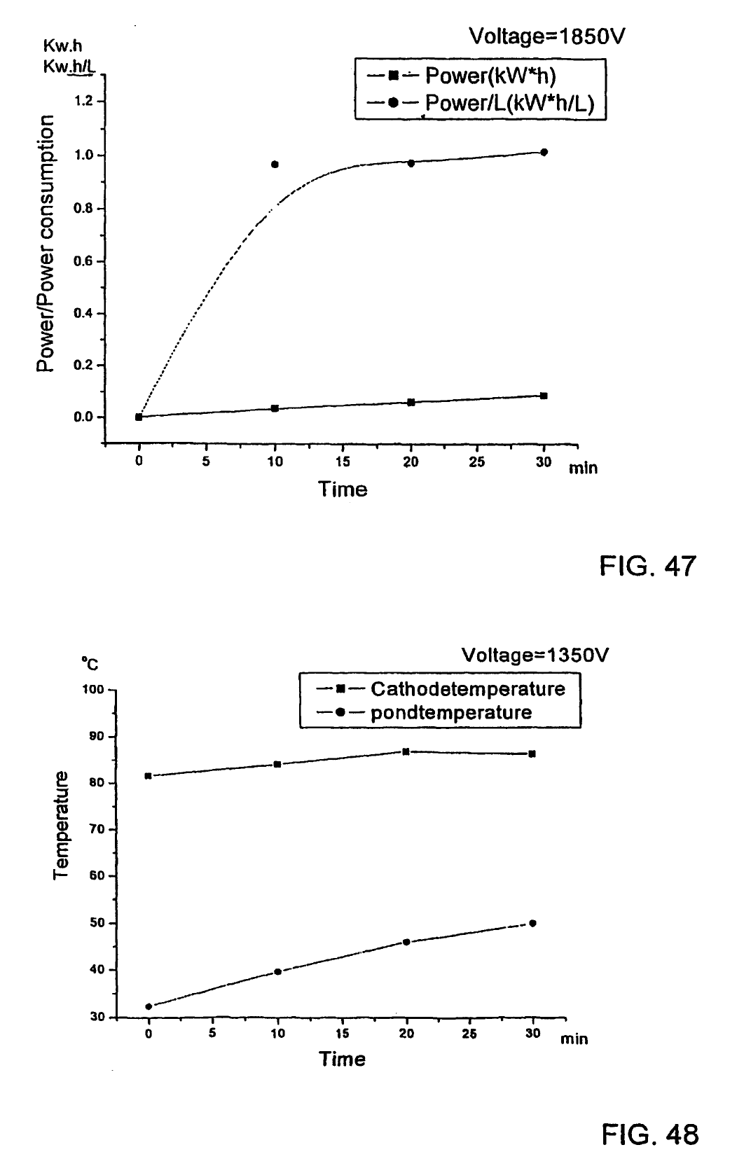

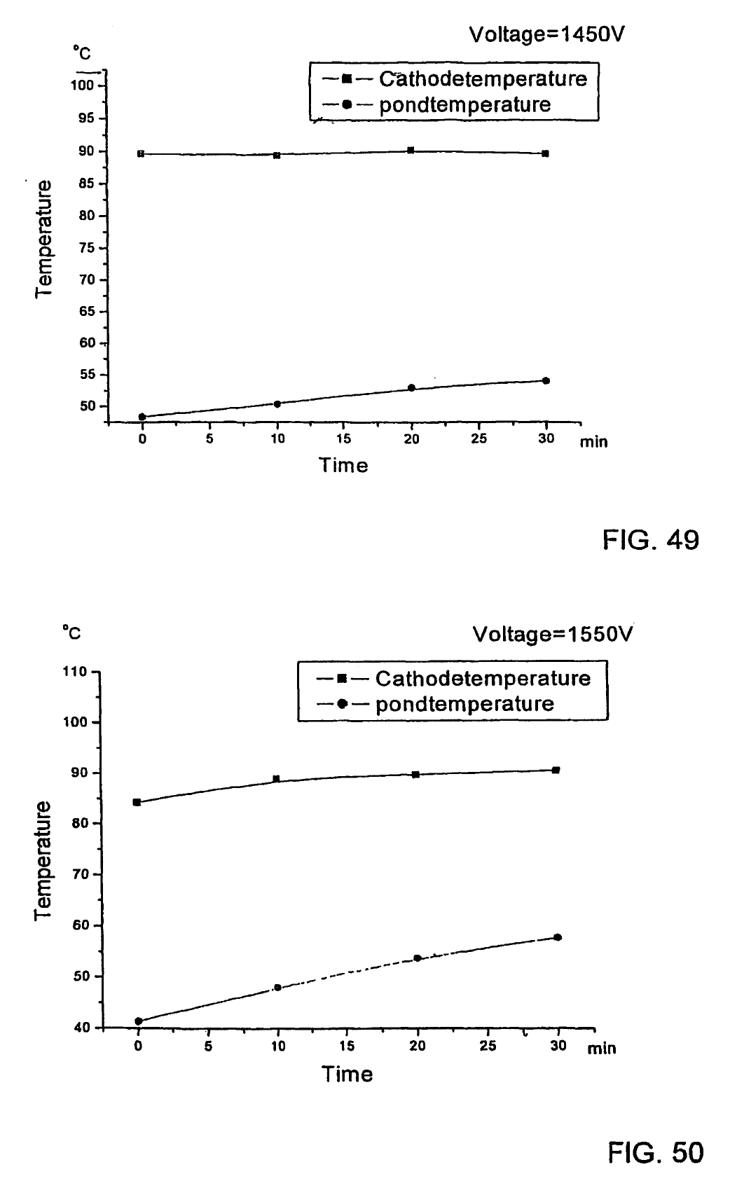

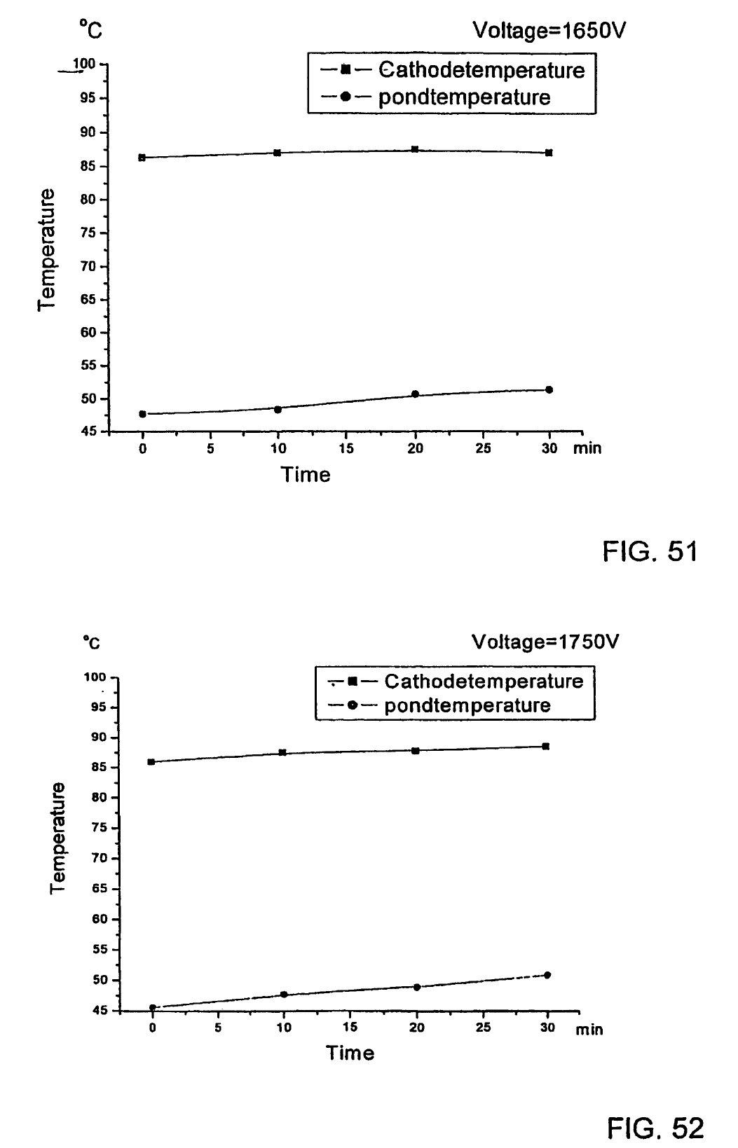

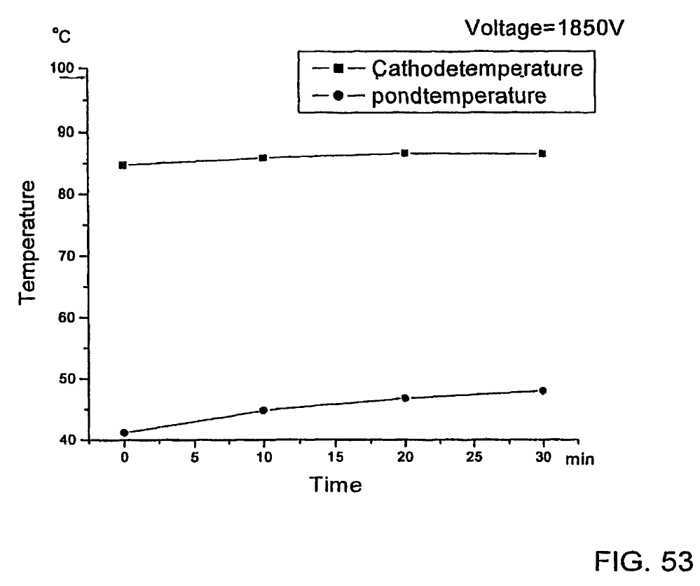

FIGS. 10-53 refer to further embodiments and experimental results in respect of the present invention.

The present invention relates to the production of non-thermal plasma contained in a liquid by generating corona discharge and or glow plasma discharge inside the bubbles or air pockets present in the liquid.

Upon passing electricity of sufficient potential through the liquid, electric breakdown of the dielectric bubble barrier results in the formation of plasma discharge inside the gas bubbles or pockets present in the liquid. In most cases glow discharge occurs near the electrodes but occasionally glow discharge is also observed away from the electrode.

The bubbles can be produced either by electrolysis, electrochemical reaction, heating of electrodes, releasing of trapped gases in the liquid, ultrasonic cavitations, laser heating, and externally introduced gases.

Bubbles produced by electrolysis of water contain hydrogen gas at the cathode and oxygen gas at the anode. Such bubbles can also contain other chemical vapors originating from the electrolyte or additives thereto.

The liquid serves as an electrolyte which provides conductivity of electricity, the source material from which gases and vapour are produced for plasma dissociation to form, for example, reduction and oxidation, radicals and neutral species. The liquid also provides an active catalytic chemical environment for forming new compounds. It also serves as containment of gases in the form of bubbles or air pockets in which the non-thermal plasma discharge takes place.

In practise, gas bubbles evolving and shrouding the electrodes during electrolysis create a dielectric barrier which inhibits the flow of current.

At the same time the dissolved gas or micro bubbles spread and diffuse in the liquid volume create a high percentage of void fractions (micro gas bubbles) which also increase the electric resistance and so raise the voltage across the liquid media.

When the voltage between two electrodes reaches a critical level, the gas trapped inside the bubbles undergoes non-equilibrium plasma transformation. This is also known as electric breakdown which enables the resumption of current flow through the bubble sheath or air pocket layer. In the case of water electrolysis, the production of hydrogen will then resume.

During plasma discharge, light emission may be observed in the bubbles in a sporadic or steady manner in short and continuous flashes near the surface of the electrodes and in the liquid media.

Continuous light spots may also be observed in areas distanced from the electrodes where suspected small air bubbles are trapped and yet remain under the influence of strong electrical field.

The temperature in the electrolyte near the electrodes has been measured to be in the region of 50 to about 90° C. with an experiment running in water for 30 minutes, which indicates that the plasma is non-thermal plasma.

The temperature variation may be influenced by electrode geometry, electrolyte concentration, level of inception voltage and current density for the glow discharge. The temperature measured directly over the discharging electrode can reach over 200° C. during reformation of methanol for example

Configurations of electrodes, size, spacing, dielectric barrier coating, electrolyte temperature, current density, voltage and reactor geometry are factors influencing plasma formation.

A special structure and arrangement to retain gas or gas bubbles close to the electrodes provide favorable circumstances for the ready formation of a steady and cyclical plasma glow discharge with lower voltage and current input.

Electrode configurations can be in following forms: plate to plate, plate to pinned plate, dielectric coated plate to plate or pinned plate or both, wire mesh to plate, wire mesh to wire mesh or to perforated plate, wire or groups of wires in perforated cylinder tube, and tube in tube.

The electrode material may be sponge porous metal electrode, electrode covered with honey comb non conductive materials and porous ceramic filter to entrench gas or using non-conductive plate with drilled holes and gas traps that retain gas bubbles and concentrate the current density next to the electrode surface.

In general keeping the bubbles close to the electrodes' surface can also be achieved by attaching a porous nonconductive nylon foam mattress and/or a honeycomb or porous ceramics slab of suitable thickness, so that the mobility of the bubbles is slowed down and at the same time the conduit for current flow is narrowed by a shading effect of the dielectric materials which in turn raises the current density locally.

For the same reason glass beads, plastic beads and beads of catalytic material ie. TiO2, graphite of suitable size can be placed between the electrodes in order to slow down the flow of bubbles.

A non conductive, heat and corrosion electrode covering material, structured to retain and trap gas bubbles which also concentrates current density through small openings arranged therethrough whilst providing an adequate exposed electrode surface for electro-chemical and electrolysis reactions, improves the generation of steady and short cyclical under liquid plasma discharge.

Multiple layers of very fine stainless mesh sandwiched between two plastic cover plates with small perforated holes have produced a steady glow plasma. The void space created by the layered wire mesh provides a trap for air bubbles as well as enlarging the contact surface for electrochemical and electrolysis reaction.

In an experiment both vertical or horizontal electrodes were covered and bonded with non conductive materials (plastic) with patterned perforation to trap gas bubbles and at the same time allowing for electrical contact of the electrodes through the perforation.

The electrode contact surface was enlarged underneath the shielding to increase gas production during electrolysis or heating. Current flow was concentrated through small holes of 1 to 3 mm leading to the trapped gas and bubbles, which underwent plasma transformation. Cyclical and steady plasma was observed with an input DC voltage ranging from 350V to 1900V and current ranging from 50 mA to 800 mA.

A non-conductive diaphragm, which does not restrict the free flow of ions and electrolyte, is placed between two opposite electrodes to prevent crossing of bubbles between two half electrolytic cells avoids remixing of the gases which have been separated by electrolysis.

A reactor may be so structured that the electrolyte is able to enter into the reactor through the separating membrane or opening form in the reactor to replenish the loss of electrolyte within the enclosed reactor.

There are other techniques which can be incorporated into the proposed invention for the enhancement of plasma generation such as pulsed power supply, RF power, microwaves, ultrasonic waves, magnetron field, and laser. Some of the above techniques may also be applied in pulsed form.

Ultrasonic cavitations in liquid (sonic-technology) will enhance the plasma formation and the catalytic reactions that benefit a number of under liquid plasma applications.

The under liquid plasma requires an input of DC or AC voltage in the range from 350V up to 3000V and current density ranging from 1 Amp to 3 Amp per cm² in dealing with a large range of liquid media. The specific voltage and current requirement for a given application depends very much on the chemical and physical properties of electrolytic liquid as well as those factors mentioned above.

The under liquid plasma method according to the current invention can operate at atmospheric pressure and ambient temperature. However an external pressure less than one atmosphere or over one atmosphere with higher temperatures does not deter the generation of plasma in the bubbles. A higher temperature in the liquid also means more active gas molecules within the bubbles, which can benefit plasma formation.

Non-thermal plasma generated in a liquid according to the present invention has advantages over known types of plasma discharge for example in gas, under water plasma arc and pulse power electric discharge, being:

It requires only simple electrolytic cells to be the reactor to perform such discharge. There is little erosion to the electrodes and wider range of electrode materials can be chosen such as stainless steel, graphite, aluminium and good conductive materials which are resistance to chemical erosion. The polarity of the electrode can be reverted if necessary to compensate the lost of electrode materials if so desired.

It works under one atmospheric pressure and ambient temperature. The liquid electrolyte will be primary source of materials for the chemical and physical reaction take part in the process. There are number of ways that bubbles can be produced within the electrolytic cell. Gas can also be introduced to the reactor where plasma catalytic and dissociation is taking place.

It is a low temperature system as the plasma discharge is non-thermal. Any excessive or undesirable high temperature can be cooled down by increasing the circulation rate of the liquid which can lose its temperature through heat exchange. Heat generated can be recovered as secondary energy.

The electrolyte (liquid) will serve as extension of the conducting electrodes in contact with the gases or vapor trapped inside the bubbles. The air gap between two electrodes is reduced to the thickness of the gas bubbles or air pocket which thus enables plasma discharge at a much lower voltage and current compared with other plasma discharge systems. Plasma glow discharge, according to the present invention, can be initiated under conditions of a voltage as low as 350V and the current ranging from 50 to 800 mA. Extra energy is not required in splitting the water molecules to transient bubbles as in the other underwater electrical discharge system which requires voltage not less than 5 to 6KV, and very high current over 200 A in pulsed supply. Plasma discharge will also take place in gas pockets or bubbles away from the electrode as long as the electric field strength is sufficient to cause such discharge.

The electrolyte also serves as a confinement of gas generated within the system, or purposely introduced gas of known properties, instead of ordinary air which may lead to production of unwanted NOx for example. Noble gas such as argon is not necessary to enhance the initiation of glow discharge sometime required in the air discharge system.

The electrolyte is also serves as a conductor and passage for the transportation of ionized species and transmission of electrons. The ionized atoms and molecules deriving from the electrolyte will be collected in their respective electrodes in the form of gas or material deposit. These ionized species are either serving as a reduction or oxidation agent in their respective half-cell. Since the gas ions produced during the discharge migrate to their respective poles to be collected individually. Hydrogen gas and oxygen gas can be collected separately.

The gas and vapor molecules and atoms inside the bubble which undergo plasma glow discharge are ionized, excited or dissociated to produce the very active species for reduction, oxidation, and the forming of neutral or radical species which in turn react with the chemical elements present in the gas and liquid interface aligning bubbles wall. The shear number of bubbles generated near the electrodes and in the liquid comes into contact with a much larger volume of liquid that provides effective treatment, breakdown, transformation of chemicals, organic matter or elements which have been targeted.

Liquid is a good media for transmitting ultrasonic waves. Sonic-excitation is beneficial for the dissociation of materials and extermination of microbes and aids the breakdown and local melting of colloidal solids during impact which also enhances the plasma oxide reduction process. The generated ultrasonic cavitations may be fully utilized to work in conjunction with the under liquid plasma discharge. An ultrasonic cavity is micro in size and uniformly distributed in the entire liquid volume. The cavities are highly vacuum which contain liquid vapor and gas, which favor plasma discharge. The high temperature and pressure reaching 10,000K and thousand of atmospheric pressure produced on the collapsing phase of these cavities work is complementary to that of the electro discharge plasma. This enables under-liquid plasma discharge to spread further from the electrodes and well distributed in the liquid volume to increase its over all effectiveness.

The electrolyte may also be in the form of mixture, emulsified liquid, colloid, foams encapsulating gas emission deriving from the liquid or introduced externally. The emulsified liquid of oil water mixture and encapsulating gas of hydrocarbon fuel with the ultrasonic irradiation will facilitate their reformation for hydrogen production.

Fine granular insoluble particles of mineral oxide such as aluminium, titanium, iron, silica etc. can be suspended in the form of colloid with the liquid which is than subjected to reduction with active ionic hydrogen atoms in a highly reactive plasma catalytic environment to become deoxidized and refined. This will be more so with the assistance of sonic impedance. The Plasma glow discharge has also demonstrated the ability to dissociate soluble ionic metal compounds, whereby subsequently the positively charged metal ions will be segregated near or by cathode electrode in the form of precipitation and plasma electroplating deposition.

The electrolyte may be a source of materials for thin film deposition with the assistance of plasma glow discharge. In addition nano size particles of certain compounds and elements i.e. Metal hydride, oxide, pure metals, semi metals, organic, ceramic etc can also be produced with the assistance of the under liquid plasma discharge in conjunction with ultrasonic cavitations mechanism to cause breakdown and reformation of certain compound. The highly catalytic, reactive and dissociation capacity of the glow discharge plasma reforms and reconstitutes chemical elements and compounds from basic atoms or molecules to form nano particles. These include organic, inorganic, metallic and non-metallic materials such as silica, titanium carbon and etc. This is also a very effective way to extract or remove heavy metals from liquid by oxidizing such as Hg to HgO; Cu, Zn, Cr and etc. to form hydroxide precipitation and ionic metal solute to be deposited by the plasma electroplating process.

The under liquid plasma creates a highly catalytic and reactive environment for chemical reactions which would not take place under normal circumstances. The reductive species i.e. H+ and oxidative radicals i.e. O−, O3, H2O2, OH− and other radical species produced in the electrolysis and plasma dissociation derived from the liquid itself. The sonic excitation action that enhances the effectiveness of plasma discharge can only be conducted spontaneously under and within liquid.

The under liquid plasma technique coupled with the sonic-excitation and electro-chemical action creates an environment of localized high temperature up to 10,000K and pressure up to thousands of atmospheric pressure that favor the generation of cold fusion phenomena.

It is a low energy system. Generally high voltage from 0.35 KV up to 3 KV with low current density rarely required more than 3 Amp/cm² will be needed to deal with a vast number of different types of the under liquid plasma process. If other enhancement method is applied the high voltage and current requirement will be further reduced.

It is a method for producing hydrogen, oxygen with water or other gases and material deposition with liquid containing chemical solute, other than the conventional exchange of ions. The molecules and atoms are being ionized, excited and subjected to dissociation to form ionized, radicals and neutral species by the influence of plasma discharge. The dissociated species can be produced near either anode or cathode electrodes. The ionized species are then attracted to their respective polarity to be neutralized to produce gas or deposition of materials. The dissociation of atoms or molecules are the result of electron collisions and a wide variety of dissociated species is produced which creates the reactive elements for reduction, oxidation, and highly catalytic environments that facilitate chemical reaction of those relatively stable compounds and elements.

No chemicals are needed as an additive in a decontamination process, of which chemicals, i.e. chlorine and ozone, could become a secondary source of pollution.

### EXPERIMENTAL OBSERVATIONS

When sufficient micro bubbles originating from the electrode surface block the current flow, the voltage rises steadily until a point of voltage inception is reached whereby some micro bubbles begin experiencing glow discharge. This precedes an avalanche effect which spreads through other micro bubbles close by.

A massive light is then emitted in a flash with a sound of bursting bubbles. The light is yellow to orange colour indicating plasma discharge in hydrogen gas at the cathode electrode. Before long after switching on the reactor, temperature in the electrode rises which contributes to the formation of vapour bubbles which creates a large bubble environment full of water vapor whereby the next succession of plasma discharge takes place within fraction of seconds.

The features which enable the trapping of gas, concentration of current density within a small region, continue replenishment of gas, steady and self regulating voltage and current power supply, electrode spacing, electrode configuration and electrolyte concentration all having bearing to generate desirable steady and short cycle plasma glow discharge.

The invention has a number of applications including:
Plasma assisted electrolysis for hydrogen generation.
Non-thermal plasma reformation of hydrocarbon and hydrogen rich compound for the production of hydrogen.
Treatment of polluted and contaminated liquid waste containing chemical and heavy metal pollutants.
Treatment of polluted gas emission and removal of odour.
Sterilization of drinking water and liquid food.
Extraction and refinement of mineral from its oxide or oxide ores.
Production of nano particles.
Enhancement of material's chemical and physical properties by plasma discharge irradiation under liquid condition. This also favours the need of any plasma reaction and treatment under liquid.

FIG. 1 illustrates a basic apparatus 1 for carrying out the method of the invention, namely generating a plasma within bubbles formed adjacent a cathode within an aqueous medium.

The apparatus 1 comprises a liquid containment means in the form of an open rectangular tank 2 opening to the atmosphere and containing an aqueous liquid 3. A stirrer 4 for agitating the aqueous liquid projects into the tank 2.

Two spaced cathodes 5 are positioned in the tank 2 alternating with three anodes 6 projecting into the tank 2 and extending generally parallel to the cathodes 5. A bubble pipe 8 is positioned at the bottom of the tank 2 for introducing bubbles into the aqueous medium in proximity to each of the cathodes 5.

The application of a suitable potential difference across the anodes and cathodes leads to a glow discharge being formed and a plasma within the bubbles adjacent the cathode. This ionises the atoms and/or molecules within the bubbles and can be used to achieve a number of industrially and commercially useful objectives.

For example it can be used to generate hydrogen gas, one of its use is in a fuel cell to generate electricity. It can also be used to neutralise harmful compounds within the aqueous medium, e.g. originating in a liquid source or a contaminated gas and treating these harmful compounds. Finally it can also be used to coat the surface of an article with a particular material.

Each of the cathodes is in the form of a perforated tube. At least one end of the tube is open and typically gas is introduced through such an open end. The side wall of the tube is perforated such that gas issues from the tube into the aqueous medium around the cathode. By contrast each of the anodes may be rod-like.

FIG. 2 illustrates a variation on the apparatus of FIG. 1. This description will be confined to the difference between the FIG. 1 and FIG. 2 apparatuses.

In FIG. 2 the electrodes extend horizontally with each cathode positioned between two vertically spaced anodes.

FIG. 3 illustrates an apparatus suitable for the generation of hydrogen. The tank contains an anode and a cathode spaced apart from each other. The electrodes are generally the same as those described above with reference to FIG. 1. The cathode is surrounded by a semi-permeable membrane. Specifically the membrane is designed to resist the passage of hydrogen and oxygen bubbles therethrough. Hydrogen gas is formed from the combining the two neutralized hydrogen ions adjacent to the cathode and then is drawn off the aqueous medium above the cathode and collected for use.

Similarly oxygen gas is formed adjacent to the anode and this is also drawn off separately and collected for use.

An advantage of this method for the formation of hydrogen fuel is that it consumes essentially less energy than other known methods and as a result will be a very attractive source of hydrogen for use in fuel cells.

FIG. 4 illustrates a tubular reactor which is quite different to the tank 2 shown in the previous embodiment.

The reactor 30 comprises a circular cylindrical body 31 with its longitudinal axis extending in a horizontally extending fashion. A pair of electrodes 32, 33 extend longitudinally through the body spaced in from the wall of the body 31. Each cathode 33 is formed by a perforated tube. By contrast the anode is formed by the body 31. Thus the single anode 31 extends concentrically around the cathodes 33, radially inwardly therefrom. A gas which ultimately forms the bubbles is pumped into the cathodes, e.g. through open ends thereof and then issues through the opens defined in the cathodes 33 along their length.

Settling tanks are located at each end of the body 31. The settling tanks 40 permit gas to be separated from liquid. The gas rises to the top of the tanks 40 from where it can be drawn off. The aqueous liquid can be drawn off through a drain point positioned below this level of aqueous medium in the tank 40. Aqueous medium can also be introduced into the apparatus generally by passing it through an inlet into one of the tanks 40.

Otherwise the method of generating plasma in bubbles adjacent to the cathodes is very similar to that described above with reference to FIGS. 1 to 3.

In FIG. 5 reference numeral 1 refers generally to apparatus in the form of a cell and associated components for carrying out a plasma electroplating process (PEP) in accordance with the invention.

The cell 1 comprises broadly a liquid containment means in the form of a bath which is filled with an electrolyte which also forms part of the apparatus or cell.

A pair of spaced electrodes are positioned in the bath, one being a cathode and the other being an anode.

An electrical circuit is formed by electrically connecting up the anode and cathode to a power supply, e.g. a mains power supply. When the bath is being used a potential difference is applied across the electrodes.

A partition divides the bath into an electrode compartment and a circulating compartment. Electrolyte is drawn off the circulating compartment and pumped through a heat exchanger to cool it and then return it to the bath. This helps to keep the temperature of the electrolyte within a suitable range during operation. In addition a make up tank is positioned adjacent the circulating compartment to replenish the level of electrolyte within the bath as and when required.

The apparatus also includes means for producing a bubble sheath around the cathode. The bubbles can be generated by gas evolved at the cathode as a result of a cathodic electrochemical reaction. This is one of the ways in which the bubbles were generated in the experiments conducted by the applicant.

There are however alternative ways of generating the bubbles for the bubble sheath. One alternative way is by boiling the solution (ebullition bubbles). Other ways of producing the bubbles are by cavitation generated by ultrasonic waves or by hydrodynamic flow. Entrainment bubbles can also be produced by a mixture of gas and liquids.

FIG. 6 illustrates an ultrasonic generator surrounding a bath similar to that in FIG. 5. The generator generates ultrasonic waves which are transmitted into the electrolyte liquid and act to generate bubbles in the electrolyte which then surround the cathode.

The cathode which typically provides the surface for deposition can be formed of a conductive material, a semi-conductive material or a non-conductive material, coated with a conductive coating. Cathodic materials that have been successfully used in this method are nickel, mild steel, stainless steel, tungsten and aluminium. The cathode can be in the form of either a plate, a mesh, a rod or wire. There may be any number of cathodes and the cathodes can be any shape or size.

Any conductive material can be used for the anodes. Graphite, aluminium and stainless steel have all been successfully used to practise this method by the applicant. Generally aluminium is preferred for the anodes. There may be any number of anodes and the anodes can be any shape.

In use the bath is filled with an appropriate electrolyte. The electrolyte contains broadly a solvent or carrier which provides a liquid environment within which electrolysis can occur and which also provides a support for plasma generation in the sense that it provides containment for the plasma generation. The electrolyte also contains a source of the material to be deposited in the form of a precursor. The electrolyte may also include additives for example for enhancing the electrical conductivity of the electrolyte and also for assisting in bubble formation and a buffer to maintain a suitable pH in the cell.

In use the article to be coated is placed in the bath where it typically forms the cathode. In some instances however it may also form the anode.

A voltage or potential difference is then applied across the electrodes and this voltage is set at a level that is higher than the firing point at which the system or cell achieves a stable glow discharge in which glow clusters envelope the cathode surface.

FIG. 7 illustrates a typical current against voltage profile for such a cell as the voltage is progressively increased. Initially there is an ohmic zone where the current increases proportionally with the voltage. After that the curve enters an oscillation zone where the current starts to oscillate. Applicant believes that this condition may be due to the fact that bubbles are evolving out of the solution and partly obscuring the electrodes. The bubbles form plasma, grow and then burst forming a shield shrouding the electrode. These bubbles block the conducting part of the cathode and this might lead to a decrease in apparent current density.

At the cathode the evolved bubbles include hydrogen generated by the electrolysis of water in the electrolyte and also by evaporation of liquid within the electrolyte. The bubbles may also be generated by other means as described above, for example ultrasonic generation.

After some time the number and density of bubbles increases until the entire cathode surface is sheathed in bubbles. At a critical voltage that is constant for a given system, known as the fire point, a glow discharge is formed. Experimental observation shows that this occurs when there is a near continuous bubble sheath around the cathode.

With a wire cathode, a tiny fireball or cluster of fireballs usually appears at the tip of the wire at the fire point. With further increases in voltage a glow discharge is established across the entire cathode. The glow discharge is dynamic and usually shows evidence of glow clusters and/or flashing through the bubble region.

The glow discharge is caused by a dielectric breakdown in the bubbles. This is caused mainly by a high electrical field strength. Due to the presence of the bubbles the majority of the voltage drop from the anode to the cathode occurs in the near cathode region occupied by the bubbles. The electric field strength in this region may be of the order of 1×10⁴ to 1×10⁵V/m.

The voltage is set at a setting of 50 to 100 volts higher than the ignition point. This may typically mean a setting of 250 to 1500 volts. A preferred voltage setting would be at the low point of the graph in FIG. 4 within the glow discharge region.

The glow discharge causes the generation of a plasma in the bubble. FIG. 8 shows the formation of a bubble sheath around the cathode. FIG. 9 shows the cathode during stable glow discharge. As shown in the drawings, applicant has observed the formation of two distinct zones during stable glow discharge.

In zone 1 where the glow discharge clusters are present there is a plasma envelope that directly shrouds the cathode surface. This envelope is where plasma deposition takes place. The plasma interacts with the cathode surface in a process similar to ion plating and deposition occurs. A film is progressively formed through nucleation and growth on the cathode surface.

Zone 2 is a plasma-chemical reaction zone which forms the interface between the electrolyte and zone 1. This zone envelopes the plasma deposition zone and is often clearly visible as a separate region with a milky appearance.

Dissociation and possibly also ionisation of the electrolyte components, including the precursor, occur in the outer zone or zone 2. This gives rise to the species that are deposited on the cathode. The species is transferred from the outer zone 2 to the inner zone 1 by the electric field strength, diffusion, and convection.

Deposition on the cathode then occurs for as long as these conditions are maintained and the precursor material is available in the electrolyte.

After the glow discharge commences the temperature of the electrodes increases in a short space of time. The temperature of the electrolyte must be maintained within acceptable limits for certain type of application. To do this electrolyte is drawn off from the bath and pumped through a cooling system as shown in FIG. 5. The cooled electrolyte is then re-introduced back into the bath. This cooling is required for both stability and safety reasons. Some of the electrolyte components are flammable. In addition electrolyte is consumed during the deposition reaction. Accordingly it is necessary to replenish the bath with make up amounts of electrolyte from time to time. A replenishment tank containing electrolytes is provided to perform this purpose.

As shown in FIG. 10, the reactor may include a pair of metal electrodes spaced apart and separated by an ion-conducting diaphragm. The electrodes can also be positioned horizontally or vertically.

As shown in FIG. 11, the reactor may also include multiple pairs of alternating anodes and cathodes with a diaphragm.

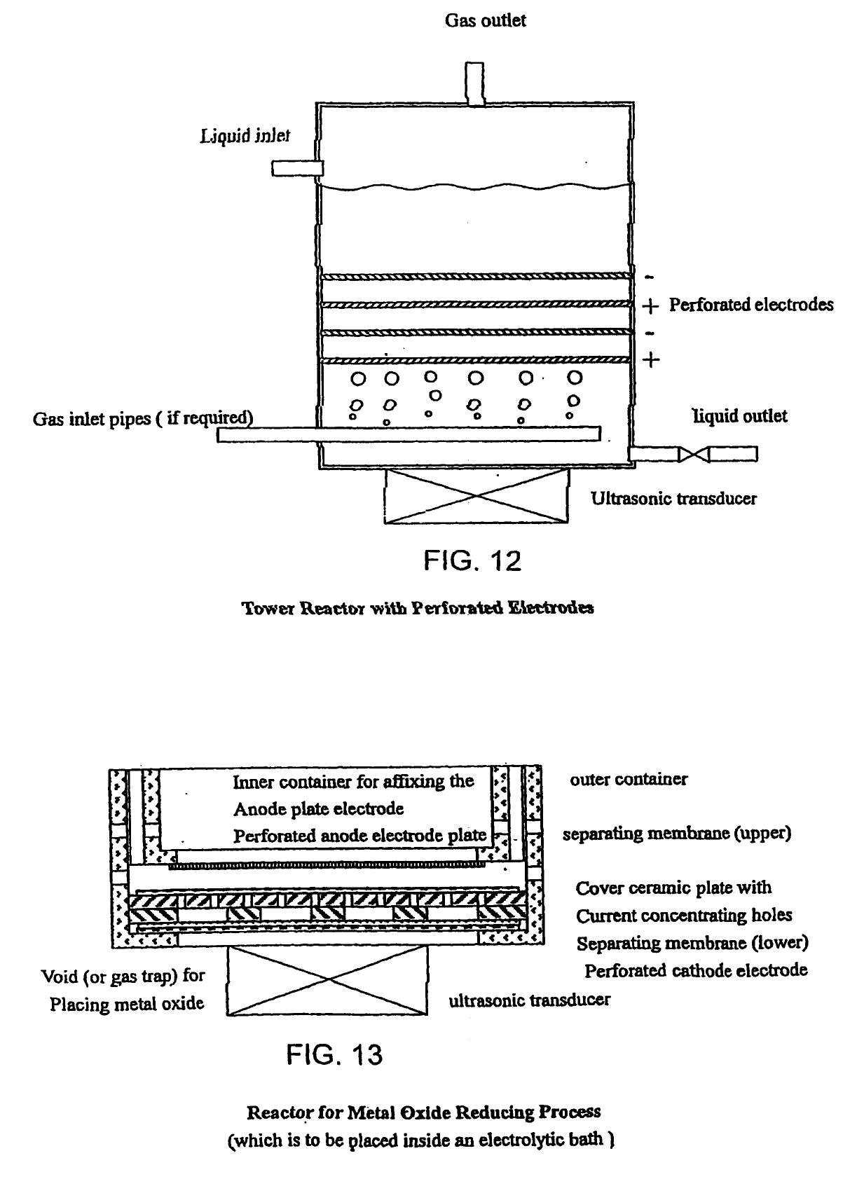

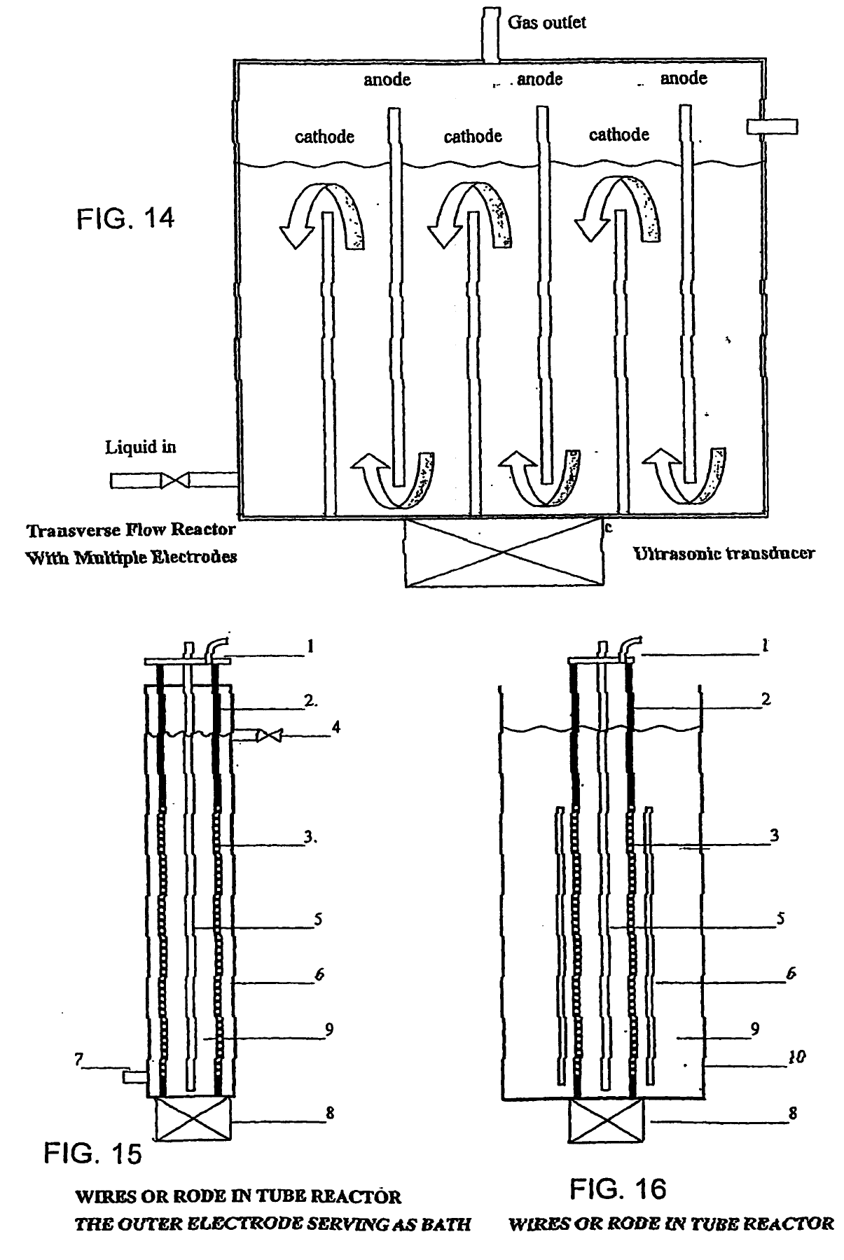

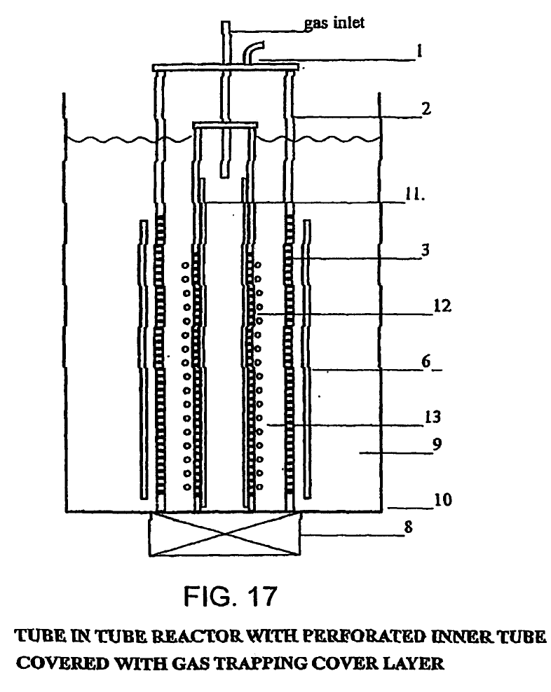

The diaphragm can be removed for decontamination and partial oxidation reformation process (FIG. 12). In the case of reduction process, the hydrogen atoms produced on the side of cathode electrode are kept well separated from mixing back with oxygen by a diaphragm (FIG. 13). It is possible to increase the through put capacity of the reactor in treating contaminants with transverse flow through multitudes of alternating electrodes of anode and cathode (FIG. 14). Wires or rods in tube reactors are suitable to adopt for hydrogen production and reduction process with the metal oxide confined within the narrow space within the cathode half cell and subjecting it to ultrasonic irradiation (FIGS. 15 and 16). Tube in tube reactor (FIG. 17) has a tube electrode within the outer tube electrode instead of wire or rod. The inner tube is covered with non conductive materials of suitable thickness with small diameter holes and gas trap forming in between the inner metal tube which also have small holes formed correspondingly. The gap between the outer electrode and inner electrode is kept close but giving a minimum 3 mm to 5 mm space between the separation diaphragm and the dielectric cover of the inner electrode, to allow free flow of electrolyte and gas. Bubbles of gas will be discharge in to the plasma discharging zone with hydrocarbon rich gas i.e. methane, natural gas, H2S to undergo reformation for the production of hydrogen gas. It can also be adopted for decontamination of polluted gas laden with NOx, SOx and particulates; and reduction process where the metal oxide will flow through the space between the electrodes with the ultrasonic irradiation keeping the fine powder in colloidal and at the same time hydrogen gas or methane gas may also bubble in to provide the extra H2, H+ and CO to enhance the reduction process.

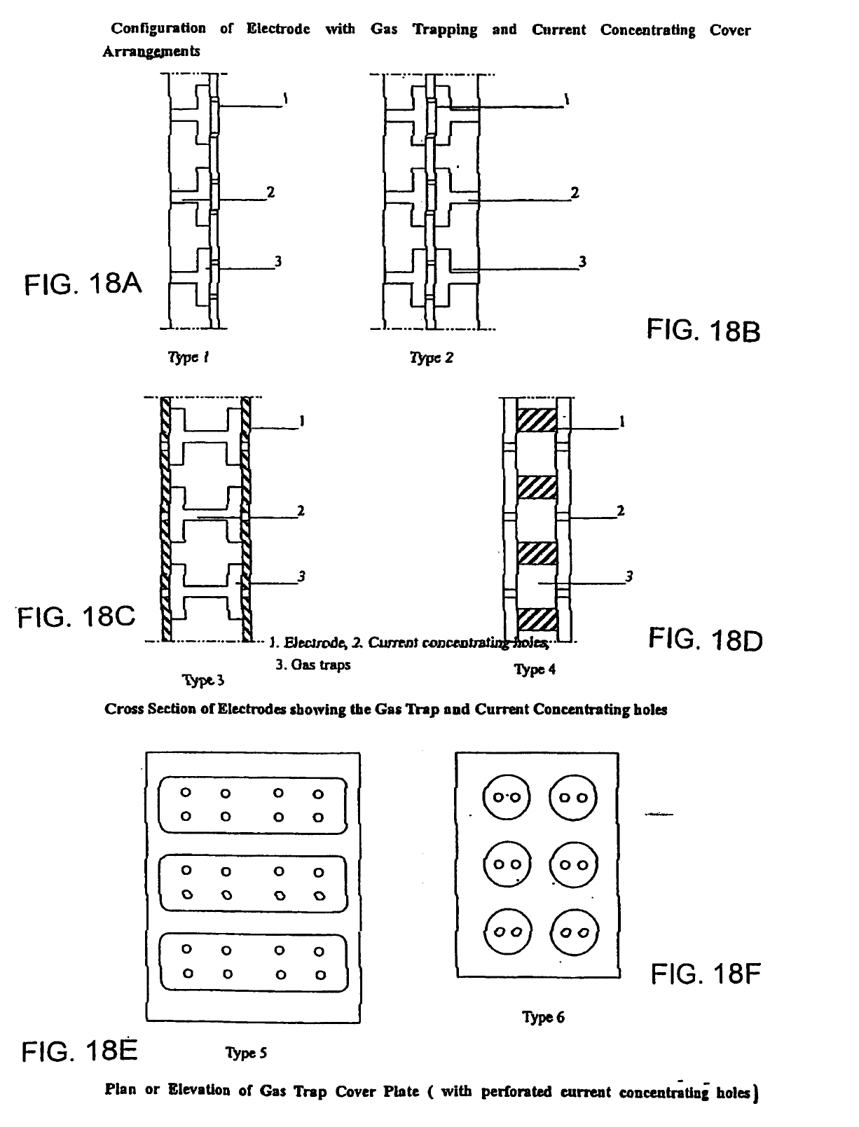

A number of gas trap and bubble retaining arrangements are shown in FIGS. 18a-f.

The under liquid plasma discharge in order to produce various reductive, oxidative, radicals and neutrals species through excitation, ionization and dissociation of the liquid molecules and atoms require high voltage input DC or AC, normally within 3 KV and current density under 3 Amp/cm2. The electrodes cathode and anode has to kept close as far as possible but not too close to avoid arcing. The electrode surface is preferably evenly flat and smooth without pronounce irregularity. Because of the need of placing diaphragm and complementary gas trapping and retaining construction on the discharging electrode a minimum distance of 6 mm to 15 mm has been experimented to produce steady glow plasma under liquid. With better material choice and engineering capability there is no reason why the electrode space distant can not be further reduced. The sizes, shapes and arrangement of the electrodes are not restricted. But usually its size will comparatively smaller than that require for the conventional electrolysis for the same gas production volume. Both the electrodes anode and cathode can be work in the same time as plasma discharging electrode especially gas trapping dielectric cover construction is provided.

Experiments have been conducted to establish the basic criteria to generate steady and rapid cyclical non thermal plasma glow discharge under liquid with basic DC high voltage and low current input at atmospheric pressure and ambient temperature leading to the proposal of a phenomenal model of reactor structure and electrode configuration which demonstrate the usefulness of bubbles or gas pocket that creates the under liquid environment for plasma discharge and it also provides the back ground of further improvement and construction of reactor unite which verify the inventive idea of under liquid plasma and it subsequent practical applications.

A reactor according to the present invention can basically follow that of a simple water electrolysis cell with one anode electrode separated from the cathode electrode with an ion conducting membrane and yet has the capability to prevent remixing of the produced gas on each half-cell. The electrolyte allows moving across the membrane or replenish through the opening in the reactor. In order to increase the proficiency of the reactor the cathode electrode is placed in between two-anode electrode and separated by a membrane. The hydrogen gas produced is isolated and collected independently. The polarity of the electrode can be reverted with anode electrode in the middle when oxidative species are needed for the decontamination process. Most importantly the simple electrode and reactor unite will form the basic module, placed inside a common bath and linked to become a major production unite, which can be individually replaced.

Despite the apparent success of the simple perforated plate to plate electrode arrangement, it does not preclude other electrode configurations and arrangements such as tube in tube, wire in tube and other flat surface electrodes having different surface structure e.g. wire mesh, expanded metals, pinned plate, sponge porous metal, corrugated plate and etc. as long as it is a good electric conductor, corrosion resistant, heat tolerance materials i.e. stainless steel, aluminium, graphite, platinum and etc. The shape and size of the electrode piece is not restricted and sometime it may form the object article to undergo plasma surface enhancement treatment.

In practice a reactor with vertical electrodes suits plasma assisted water electrolysis, reformation of hydrocarbon liquid fuel, production of nano materials and decontamination process, while the reactor with horizontally position electrodes suit reformation of hydrocarbon gas such as natural gas, methane, hydrogen sulphurs and the like.

The developed ability in generating steady plasma discharge can well be adopted for other useful purposes such as thin and thick film deposition and additional method in the creating of cold fusion.

There have been a series of experiments conducted to generate non-thermal plasma under liquid by utilizing the gas bubbles self generated during electrolysis, electrochemical reaction, heating and releasing of dissolved air or gases in the liquid. Bubbles can also be produce with the influence such as transient bubbles created by shock waves resulted from pulsed power input, ultrasonic cavitations, laser heating and hydraulic impingement. External introduced gas (eg. air & fuel gas) is found to work well in providing bubbles environment for ready plasma discharge in a steady manner. A number of experiments have also been conducted to test the applicability of under liquid plasma in the field of hydrogen generation, hydrocarbon fuel reformation, sterilization and decontamination and reduction of metal oxide. Because of the restriction of the power converter that some result is less than ideal but it all indicate the potential of the under liquid plasma which is in the first place having the same physical/chemical capability as its counter part operating in gases environment in exciting, ionization and dissociation, but with some distinctive advantage which has well been described in the foregoing text.

Generation of steady plasma discharge under liquid has been one of the primary objectives in the research. In general the generation of steady plasma glow discharge are influenced by a number of factors, such as physical and chemical properties of the liquid, its conductivity, temperature, electrode type, electrode spacing, gas retaining or trapping arrangement, current density, voltage input, reactor construction, liquid circulation, influence of ultrasonic irradiation, pulsed power input and etc.

There are of course a number of electrode shapes, size and configuration one could choose. In order to find out the how important is the supply of bubbles or gas pocket affects the generation of plasma, a gas retaining or trapping covering with current concentrating conducting holes over perforated plate electrode is formulated, which has proved effective producing steady glow plasma discharge within the range of 350V to 2 KV (2000V) and current up to 850 mA, but most the time around 100 to 300 mA range. This is considered low in compare with other under liquid plasma system (i.e. Plasma arc, pulsed high voltage and current electric discharge).

Throughout the experiments, a horizontal reactor was used. However an alternative reactor is a vertical reactor.

### INTRODUCTION TO THE EXPERIMENTS

Several groups of experiments have been conducted:

1. Preliminary trial experiments

2. Plasma assisted water electrolysis

3. Reformation of methanol

4. Reformation of emulsified diesel

5. Reformation of LPG as hydrocarbon gas (methane is not available in the market)

6. Decontamination or sterilization of food drink

7. Reduction experiment of TiO2.

In the preliminary trial experiments a number of electrode types have been adopted and have eventually select the wire to plate configuration and perforated plate to perforated plate or wire mesh as the most suitable under the limiting power supply condition where max. voltage available is 2000V and the maximum current is 1200 mA. In reality the current input is voluntarily restricted to work below 900 mA for duration not exceeding 30 minutes to avoid damage to the converter which has happen in a number of occasion which caused stoppage of the experiments for weeks.

To overcome the power supply limitation and to achieve steady plasma glow discharge, a gas retaining or trapping cover or layer with current concentration holes has been devised to cover the discharging electrode surface (perforated electrode plate) which is the basic features adopted in the construction of reactor.

In the trial experiments, it has demonstrated that infrequent visual plasma discharge begins with voltage of 350V and steady plasma can be achieved in around 550V. The initial current input reaches 850 mA and began to fluctuating in the range of 150 to 650 mA. In many occasion the current fluctuated at 100 mA to 350 mA.

Through these experiments the mechanism of generating bubbles or gas pocket dielectric barrier which impede the current flow leading to increase of voltage until an inception voltage is reached and cause the electric break down in the formation of plasma inside the bubble and the current immediately return to its normal flow and subsequently impeded for another cycle of discharge is established. When the discharge is infrequent which resemble corona streamer discharge. But as the voltage increases the glow discharge is becoming a continued glow over an extend electrode surface resembling a glow plasma discharge. The color of the discharge appears in orange yellow or red color in the electrolysis of water and the temperature of the discharging electrode is ranging from 50 to about 90° C. and the temperature of the bath liquid is ranging from 40 to 70° C. No sign of any damage to the electrode or its covering plastic gas trapping plate after prolong experiment. When the voltage allow to increase beyond the glow plasma region, plasma arc begin to occurs and become intensive bright blue discharge when voltage further increased and damage to the metal electrode and plastic covering plate are obvious.

In two occasions hydrogen production is recorded to produce in quantity with equivalent energy conversion efficiency up to 56%. Due to damage to the reactor by plasma arc that the experiment cannot repeat with a different model of reactor which is designed to achieve low current input and early high voltage response. However with the apparent success of the trial experiment that a more suitable reactor can be designed specifically for the purpose of hydrogen production for the plasma assisted water electrolysis and higher energy efficiency figure with small reactor can be developed.

### PLASMA ASSISTED WATER ELECTROLYSIS

Experiments, the behaviour of plasma discharge at different voltage input is investigated. Despite of the apparent bubbles boiling inside the reactor the total volume of gas produced is unexpectedly low.

This may have been attributed to the horizontal reactor adopted through out the experiments that allow the produced hydrogen gas to recombine with the hydroxyl ions back to water. Vertical reactor would be more suited for the plasma assisted water electrolysis where the produced hydrogen gas will rise quickly to top of reactor and can also channel away from the area abounded with OH ions.

In this experiments plasma discharge begin to occur at 1350V with current fluctuating around 100 to 200 mA. At about 1550V the reactor produced highest volume of gas. Plasma arc discharge occurs at 1900V and is becoming vigorous when the voltage is increased further. KOH of 0.02% concentration has been used as electrolyte additive through out the experiment.

The production of gas appears to have a linear relation with time but various substantially with different voltage input. The rate of energy consumption is increasing slowly with time in a constant rate which various with the voltage input and its corresponding energy consumption per unit gas volume produced is having a peak at the first 10 minutes of the experiments and level off with time. The temperature in the electrode rise sharply to from 50° C. to 90° C. and is also maintain more or less at that level through out the test. The temperature in the bath liquid within the reactor rises slowly from its ambient temperature at around 50 to 55° C.

### EXPERIMENTS WITH METHANOL

There are several sets of test have been conducted with the aim to find out how different hydrocarbon fuel will be affected by the non-thermal plasma under liquid. Methanol water mixture with methanol concentration ranging from 5%, 10%, 15%, 20%, 25%, 30% and 40% are tested with method and equipment set up similar to that of plasma assisted water electrolysis. There are three independent tests to each methanol concentration. It has been observed that the gas production is peaked at 25% methanol concentration and the energy consumption per unit gas volume produced is also lower than the others and is nearly at constant rate around 0.0225 Kw.h/L. The voltage input for each test is kept at 1850C and the current fluctuating in the range of 100 to 200 mA. The temperature measured at the cathode electrode starts at 80° C. and rise quickly to reach over 200° C. at the end of 30 minutes experiment. The temperature recorded in other test stay within the range of 60 to 80° C. The temperature of bath liquid at 25% concentration stays in the range of 50 to 60° C., which is in average with the others.

The greatest surprise coming out of the experiments is that the produced gas is composing of two gases. One is hydrogen gas and the other is oxygen gas and no trace of carbon dioxide is found. Repeated examination of the gases produced shows the same result and the hydrogen is having an average value of 51.3% and oxygen 48.7%. This is later found out that the present of oxygen in the gas is the result of removal of separating diaphragm. Acidic electrolyte is more preferable as conducting reagent in order to increase hydrogen gas percentage in the produced gas. This is testified in the latest experiments using sulphuric acid of 0.02% concentration.

A set of experiments with the use of 40 KHz ultrasonic bath having methanol concentration of 10%, 15%, 20% and 25% with the same reactor and equipment arrangement have been conducted to find out the influence of ultrasonic irradiation. It has been observed that gas production at 25% is substantially higher than the others and yet the energy consumption per unit gas volume produced is around 0.015 Kw.h/L through out the 30 minutes experiment, which is lower than that without ultrasonic irradiation.

The chromatographic analysis of the out put gas having an average value of 97.56% hydrogen and 2.4039% of carbon monoxide.

Chromatographic analysis of gas produced by reformation of methanol with ultrasonic irradiation. Methanol concentration at 25%, and conductive reagent 0.02% sulfuric acid.

TABLE 1

| | resident time | composition | |
|---|---|---|---|
| Test | Min | V/V % | gas type |
| First test | 0.364 | 98.9937 | H2 |
| | 1.047 | 1.0063 | CO |
| Second test | 0.364 | 96.7418 | H2 |
| | 1.047 | 3.2582 | CO |
| Third test | 0.354 | 96.9719 | H2 |
| | 1.048 | 3.0281 | CO |
| Average | | 97.5691 | H2 |
| | | 2.4309 | CO |

### EXPERIMENTS WITH LPG

Decomposition of LPG by under liquid plasma has been conducted (methane or natural gas is preferred but none is available in the market). The LPG is allowed to pass through the horizontal reactor through the perforated anode plate and enter the reactor and trapped at the cathode plate where plasma is taking place at voltage 1980V and current at 100 to 130 mA input. C3H8 and C4H10 are the two main components of LPG, it is expected that the volume output having been subjected to plasma dissociation should be larger than the original input volume. This is found to be so that the out put gas volume increases by about 50%%. The experiment is conducted together with ultrasonic irradiation. It is regrettable that the chromatogram is in capable to undertake analysis of the out put gas composition. The next set of experiments should be conducted with methane or natural gas so that more definitive result could be obtained. Rudimentary analysis of the produced gas has shown the present of H2, CO2 and C3H6 etc.

### REFORMATION OF EMULSIFIED DIESEL AND WATER WITH ULTRASONIC IRRADIATION

Decomposition of emulsified diesel with distillate water has also been carried out. Diesel oil in 25% and 50% by volume has been emulsified by adding 1.25% emulsified agent inside the ultrasonic bath. Since the diesel oil is dielectric additive of KOH is needed. The emulsified liquid is subjected to plasma discharge at voltage 1850V and current fluctuating from 100 to 200 mA for a period of 30 minutes. The temperature of the cathode electrode is increasing from 70° C. to about 94° C. during the experimental period. The gas volume produced 160 mL with 25% diesel and 1740 mL with 50% diesel, which is substantially higher and its energy consumption is 0.1213 Kw.h/L. It is clearly indicated that gas production is proportion to the diesel contend in the emulsion. Because of the limiting power supply, the voltage at 1850V is merely adequate to produce some plasma discharge but it is far from establishing extensive vigorous plasma with higher current and voltage input, which would produce more gas.

### STERILIZATION (DECONTAMINATION) OF MULBERRY FRUIT DRINK

The ability of non-thermal plasma to decontaminate noxious chemicals and gases has already established. This experiment is conducted to find out how well the under liquid plasma may apply in the field of beverage sterilization with low level of plasma irradiation and keeping the treated liquid within an acceptable temperature.

Two litters of 15% concentrated fruit drink is placed in the bath where a horizontal reactor is submerged. The bacteria count and mold colony count is obtained before the forty minutes test. Sample of the fruit drink is extracted at 20 minutes and forty minutes. The mulberries drink is having good natural conductivity that no conductive additive is required. Apply voltage is kept at 1200V and the current fluctuated around 200 mA. The temperature at the electrode is maintaining around 62° C. and the bath liquid (fruit drink) is kept at around 50° C.

TABLE 2
The micro-organism count

| Time (min.) | bacteria count/ml | mold colony count/ml |
|---|---|---|
| 0 | 3400 | 37000 |
| 20 | 1300 | 17000 |
| 40 | 90 | 10 |

The favor and color of the fruit drink has not changed after the test. The bacteria sterilization is 97.5% and that of mold colony has been sterilized more than 99%. This has given proof that the under liquid plasma is having the same capability as those operate in gases environment.

The time for the treatment could be reduced by providing force circulation of the liquid and increasing the electrode size. Sterilization of drinking water imposes no limit on the temperature. Higher voltage input for better plasma glow discharge spreading over larger and multiple electrodes should be able to remove all harmful chemical substance, bacteria, biological matters and microbial meeting the municipal requirement for drinking water.

### REDUCTION OF METAL OXIDE

One trial experiment to reduce TiO2 back to Titanium has been attempt with little success. In the X-ray diffraction test minor trace of titanium nitride and titanium monoxide (TiO) is found.

In the experiment only minor electrolyte of 0.05% KOH with 25% methanol added to the distillated water to increase the production of hydrogen. Applied voltage is fixed at 1850V and the current fluctuated in the range of 200 to 500V. Ultrasonic irradiation up to 40 KHz is also provided through an ultrasonic bath. Temperature recorded in the bath liquid rising from 46 to 75° C. at the end of 60 minutes test. The fine TiO2 with the irradiation of ultrasonic is suspended in the bath liquid in colloidal with milky white color, which gradually become milky yellow color towards the end of experiment. The bath liquid also becomes viscous.
The X-ray refractive d value of TiO2 are:
Before the experiments 3.512, 1.892, 2.376
After the experiment two group of d value is not observed before the experiments
   a. 2.089, 1.480, 2.400
   b. 2.400, 2.329, 2.213
This indicates a new material at the position between TiO and n-Ti3N2-x.

This experiment indicate change did happen to the TiO2, but because of the limiting voltage and current input which has not provide the intensity plasma discharge needed to effect the reduction process properly. Higher concentration of either HCl or H2SO4 should be use as reagent demonstrated in the following chemical reaction and in the same time serving as electrolyte. The horizontal reactor is not a suitable piece of equipment to undertake such experiment; it is adopted merely for convenient. A wire in tube and tube in tube reactor would be a suitable candidate, which will keep the metal oxide expose to plasma discharge through out the experimental period. Further more hydrogen or CO gases produced during the process may be recharged back to the reactor to enhance the reaction. (Methane is a suitable gas for this type for the reduction process, as both hydrogen and CO gas will be produced to enhance the reaction). The following are the chemical formula, which suggested by transforming TiO2 to either TiCl4 or TiOSO4 as soluble ionic compound will facilitate its reduction with prolong exposure to active atomic hydrogen under the influence of plasma catalytic environment.
TiO2+4HCl→TiCl4+2H2O, TiCl4+4H→Ti+4HCL.
TiO2+H2SO4→TiO(SO4)+H2O, TiO(SO4)+4H→Ti+H2SO4+H2O
Where TiCl4 are readily produced by established process from ilmenite.

Similarly, aluminum oxide Al2O3 can first be transformed to AlCl3, which is soluble ionic compound, are to be extracted by electro deposition enhanced with plasma reduction and plasma electroplating process.
Al2O3+6HCl→2AlCl3+3H2O, 2AlCl3+6H→2Al+6HCl.

In the case of electrode positive oxide such as Fe2O3, it can be reduced with present of ionized atomic hydrogen and present of carbon monoxide with the catalytic reactive plasma irradiation.

Fine metal oxide powder irradiated with ultrasonic waves will maintain in colloidal form allowing them to expose to the reduction agent of atomic hydrogen and or Carbon monoxide. The process of ultrasonic cavitations and collapse is also known to create extreme localized high temperature up to 10,000K and thousands of atmospheric pressure together with the high temperature at the impact point of the fine powder particles is all beneficiary effect to the entire reduction process.

### DETAILS OF THE EXPERIMENTS CARRIED OUT

### Establishing Generation of Under Liquid Plasma

Distillated water is used in the experiments with 0.05% KOH as conducting reagent. The voltage is the controlled at 1250V & 1850V. The current is raised in step of 100 mA until it reaches 850 mA. At the beginning the voltage remain low and gradually build up with more gas bubbles is generated. Once the reaches a certain high level the current drops immediately. The self regulating current and voltage input of the power unit automatically switch from current input control to voltage input control. At 45 second after switching on the experiment, the voltage rose to 470V and the current dropped below 500 mA. From 3 min. 10 sec to 5 min 20 sec, the voltage has risen to a relatively high level while the current is kept on fluctuating. After a period of unstable voltage and current movement they become stabilized at 20 min with the characteristic high voltage and low current. At this instant prominent glow is observed at the perforated cover plate (current concentrating holes). The temperature of the cathode electrode has risen and maintain at around 70° C.

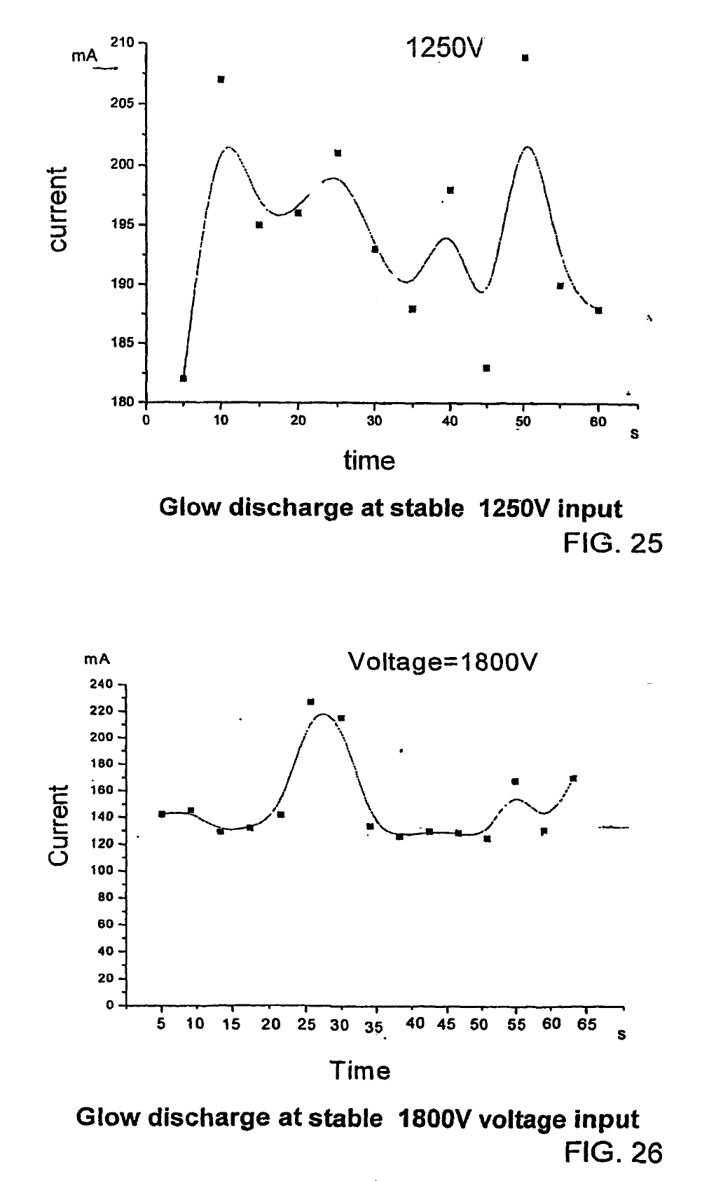

FIG. 25 shows the current fluctuating with stable 1250V voltage input with steady plasma glow discharge.

The temperature of the cathode electrode increase at fast rate at the beginning and become steady at 5 min time and rise slowly to a highest temperature about 96° C.

### OBSERVATION

### Generating under Liquid Plasma

In accordance to the experimental observation, it is possible to generate non-thermal plasma under liquid providing a certain condition is met to provide suitable power supply condition, electrolytic liquid, reactor and other supplementary equipments.

The design of the reactor with relative lower voltage supply and limiting power rating (restricted current input) requires special construction to trap or retain gas and at the same time to raise the current density at the discharge area. The size of gas trap or chamber should be of suitable size. If the gas trap or chamber is too big, the trapped gas is too thick which requires much higher voltage for discharge breakdown and prolong the time of each cycle of discharge. It becomes difficult to maintain rapid cyclical steady glow discharge. The perforated covering plate is also an important part of the electrode structure concentrating the current density. The thickness perforated plate and gas trapping chamber should be well controlled so that the electrode gap spacing will not be unduly widen which also influence the voltage requirement. The size and disposition of perforated holes can be determined by few trial and errors. Wide electrode spacing increase the voltage input requirement and unsuitably close electrode spacing will cause early occurrence of plasma arcing with high current surge and generation of temperature that will damage the electrodes and their attachments.

The power unit should be of adequate power rating. The electric break down depends highly on the high voltage supply. If the power rating of the converter unit is inadequate, it will easily subjected to damage during sudden high current surge upon cyclical electric breakdown. There will be no plasma discharge if the power input is not meeting requirement.

The electrolytic liquid should have suitable conductivity, not too low nor too high. Voltage can not be easily raised between two electrodes with high conductivity in the liquid and no plasma discharge would be generated without high voltage input. The discharging electrode may be fully encapsulated inside a bubble barrier, but with high conductivity in the liquid allow the current transmitting through the bubble liquid interface which prevent raising of voltage. If the conductivity is too low, the bubble barrier is forming a complete dielectric barrier which require a much higher inception voltage to cause electric breakdown or discharge and in the same time that the passage of current is becoming too low resulting low current density which also influencing the occurrence of discharge. A much higher breakdown voltage (discharging voltage) is in the form of electric arcing in gaseous condition will take place which is no longer considered non-thermal under liquid plasma.

### CONCLUSIONS

1. Gas layer or bubbles form the dielectric barrier that provide the environment for building up the discharge voltage and gaseous space for plasma discharge to take place. High voltage and relatively low current input is characteristic of under liquid plasma.

2. With the characteristic high voltage and low current requirement, the under liquid plasma can be generated over a wide range of liquids. The electrolyte liquid can be acidic, alkaline and solution of salts. Liquid containing conducting impurities or mixture of organic compound may also serve as electrolyte such as the case of tape water and fruit drinks.

3. There are a number of factors which would affect the generating of under liquid plasma such as voltage, current density, configuration of electrodes, area of electrode surface, electrode gap spacing, electrolytic physical and chemical properties, gas retaining and trapping arrangement, provision of plasma enhancement, ultrasonic cavitations, pulsed power supply, ambient temperature and reactor construction. This appears complicated, but the experiments undertaken have demonstrated that all the mentioned factor can be manipulated to achieve generation of stable non-thermal plasma at one atmospheric condition.

4. Plasma is the fourth state of matter. It has been wide employed in the field of chemical, electronic, materials and energy industries. Plasma generated under liquid has its own intrinsic characteristics and advantages, which has already proven a useful tool to for plasma electroplating or deposition of both metallic and non-metallic materials. It will find its application in the plasma assisted water electrolysis for hydrogen production; reformation of hydrogen rich compounds or hydrocarbon fuel (gas and liquid); decontamination of both liquid and gas pollution discharge containing persistent harmful chemicals, dissolved heavy metals and organic and biological contaminants; sterilization of fruit drinks, portable water supply; and reduction of material oxide such as oxide ores, metal oxide as an alternative method metal refinement. It is confidence that with the proposed under liquid plasma generation and establish basic scientific information would form the bases for further refinement leading to practical new applications put forward in the patent application.

### PLASMA ASSISTED ELECTROLYTES FOR HYDROGEN PRODUCTION

Water electrolysis is still in use for production of pure hydrogen. Its production is restricted because of it relatively low energy conversion efficiency. In order to achieve higher energy efficient, electricity voltage is to keep low to avoid energy lost through heat conversion. There are also claims that the energy efficient can be improved with improved electrode configuration, increase of reactive surface, closing the electrode gap and increasing pressure. The PEM solid electrode system is in its early development and its efficiency remains similar to that of water electrolysis system. In any case the basic principle of water electrolysis has not changed since it put to use. The electrolysis as a whole considered non-competitive with other production process by reforming hydrocarbon fuel, but it has the advantage of being a clean process producing high gas purity and CO2 is not produced.

The hydrogen bubbles evolving from the electrode surface slow down with time when tiny bubbles is gradually built up and smothering on the electrode surface which are not easily to be dislodged from the electrode surface and the rate of hydrogen production reduced further as those tiny bubbles become barrier of current flow between the two electrodes.

The proposed invention is closely related to water electrolysis process but mechanism of separating hydrogen from water molecules is different. Generating non-equilibrium plasma within the bubbles that smothering on the electrodes will breakdown the dielectric barrier bubble layer to resume normal flow of current. In the same time water molecules contains in the bubbles and come in contact with plasma discharge will be dissociated to produce extra hydrogen. In addition, the vigorous plasma discharge near electrode surface will also create hydrodynamic condition, which will wash away the fine bubbles that block the current flow. The mechanism of producing hydrogen by plasma discharge is different from the conventional electrolysis which split the ionic water molecules by electro-polarity attraction, while in the plasma discharge the water molecule is broken down as the result of electrons collision. The water molecules under the plasma discharge irradiation would loose one electron due to electron collision to yield H2O+e→OH+H₊+e

The produced hydrogen is of high purity. Ordinary portable water or rainwater with very low concentration of electrolyte can be used as the main source of material, instead of distillated water, as they contain sufficient impurity to be slightly electro-conductive.

The experiment has demonstrated that hydrogen gas can be produced with plasma glow discharge as a supplementary process to conventional method. The energy required to produce 1 cubic meter of hydrogen with plasma glow discharge with the very rudimentary reactor has achieved an efficiency of 56% which can be further improved with better engineering, by closing the electrode gap distance, select the right concentration of electrolyte, reactor construction and better means in trapping and retaining gas near the discharge electrode.

High temperature up to 90C is recorded in the electrolyte, which increases within very short time of the reaction. This may in part due exothermic reaction of recombining H and OH to water. The excessive heat can well be utilized as secondary source of energy. The gas or vapor bubbles by heating assuming greater importance as source materials for plasma dissociation leading to the production of Hydrogen. The high purity oxygen co-produce is also a valuable by products of many applications.

Since high voltage with moderate current is needed in the plasma process, the production rate per unite area of electrode surface is high that a smaller reactor would be needed for the production of hydrogen, especially when other plasma enhancement method is employed such as ultrasonic cavitations, pulsed powers and RF input.

The electrodes could be of any conductive materials such as aluminium, stainless steel, graphite, tungsten, platinum, and palladium etc. The size of the electrode for the plasma discharge is much smaller than that required by the conventional electrolysis to produce the same quantity of gas. As the result a smaller reactor would be possible.

Sponge porous electrode will increase the reactive surface to produce electrolysis gases. In the experiment several layers of fine wire mesh has been packed tight together to mimic a sponge porous electrode plate.

Some of the basic electrode configuration is: plate to plate; perforated plate to perforated plate; plate or perforated plate to wire mesh; wire mesh to wire mesh; plate to pinned plate; dielectric coating on one or both electrodes plate or mesh or pinned plate, tube in tube and wire in tube arrangement. It is noted that electrode configuration including any lining or covering materials that help to concentrate the current density and having the ability in retaining gas around the electrode would be adopted which will help to lower the voltage and current requirement to generate steady plasma discharge.

In order to create an environment for steady and short cyclical plasma glow discharge as already mention in previous text, the electrode configuration will be so structured to retain the bubbles and concentrating the current density and yet keeping the true electrode gap distance to minimum. This achieves by creating suitable voided space either in the metal electrode or in the covering materials to retain gas and in the same time having the mechanism to concentrate the current density to a localized discharge point. This will lead to wide variety of design and choice of materials to satisfy plasma discharge requirement.

In order to avoid recombination of H+ and H2 with OH ion in reverting back to water, the hydrogen atoms after regaining its lost electrons through contacting the cathode should allow to escape quickly away from area abounded with other oxidation species and radicals. This has greatly influenced the productivity of hydrogen gas. If H+ and OH is allowed to recombined, despite of the apparent bubble boiling in the reactor very little gas can be collected and the temperature in the reactor rise quickly which could well be the exothermic effect of recombination of H+ and OH.

The hydrogen produced is to be collected in separate from the oxygen. Since the produced hydrogen gas contain a fair amount of water vapor, the hydrogen gas is collected by passing through a water chiller or other known method, so that the measured gas volume is at room temperature with minimum contend of water vapor.

The basic plasma assisted electrolysis cell or reactor can be produced in modular form which can be packed side by side and place inside a single electrolytic tank with their respective power and out put gas collected to form a major production unite. Several reactor types can be employed for the production of hydrogen. Rod or wire in tube reactor, tube in tube reactor, single or multiple cell reactors is also suitable for the plasma assisted water electrolysis. The gas retaining and current concentrating cover will be affixed on the cathode electrode facing the anode electrode. Horizontal reactor with the cathode with gas retaining cover will be placed on top of anode which is separated by a diaphragm and the hydrogen gas is allow to collect in isolation.

The introduction of ultrasonic cavitations into the electrolytic liquid will be much easier that the electrolysis bath becomes the ultrasonic bath where ultrasonic transducers can be attached to the bath externally. A mixture of sonic frequency will be used to avoid the occurrence of dead sonic zone. The introduction of sonic excitation through cavitations will enhance the production the performance of plasma-assisted electrolysis.

Pulsed high voltage supply of DC with square wave of single polarity from 5 KHz up to 100 KHz finds to be beneficiary to generate plasma with much reduced voltage.

The distinctive advantage of the under liquid plasma enables ionized species migrate to the respective half cell and electrodes which will avoid and minimize remixing of the produced hydrogen and oxygen reverting back to water and creating hazardous explosive condition. The oxygen is considered as by product which can be collected for use or it can be channelled to combustion chamber if hydrogen is used as direct fuel for combustion engine.

Water is the primary source material for hydrogen production, which is economically available and of unlimited supply. It is a completely clean source material that produce no unwanted by products.

The anode may be gradually losing its materials due to electro transportation. But it will be a very slow process. In practice the polarity of electrodes can be reversed which reverses the materials transportation and deposition. Conductor materials that are inert of electro chemical corrosion will be a good choice to serve as electrodes.

Chemical conductive reagent may be added to water to increase its conductivity and foaming agent to enhance generation of bubbles. The electrolyte can be of acidic or alkaline base. The concentration of the electrolyte is to be maintaining for best result. High electrolyte concentration increases liquid conductivity as well as productivity of gas bubbles but it might prevent raising voltage required for discharge as the current flow between electrode will not be inhibited by the present of bubbles. However very low concentration of electrolyte will favor dielectric break down of bubbles, as lesser current will be conducted away by liquid media in between bubbles. It has been found that either acidic or alkaline electrolyte with 0.02% concentration work extremely well in maintaining steady glow discharge with DC voltage ranging at 350 to 1800V and current 100 to 800 mA.

Tap water has been used without adding any conducting reagent works unexpected well, most likely due to present of impurity and high PH, in the plasma-assisted electrolysis where steady glow discharge occurs at around 450V to 900V and current around 200 mA to 350 mA. The power input requirement varies in accordance to electrode spacing, electrode and reactor configuration, electrolyte concentration and the structure of gas retaining arrangement. Again other plasma assisted method such as pulsed power input and ultrasonic cavitations etc. are also help to lower the power input requirement.

The process is in general conducted at one atmospheric pressure. Increase of pressure will slow down upward movement of the bubbles and increase of boiling temperature.

Some increase in temperature in the electrolyte is not detrimental to the generation of plasma. Water vapor bubbles provide the source materials and active environment for plasma discharge. In general electrolyte temperature is well below boiling point as non thermal plasma produces little heat. The temperature sometime rises quickly in the electrolyte due to occurrence of infrequent plasma arc and exothermic in the recombination of H+ and OH− in quantity.

During the steady glow discharge, vigorous bubbles with yellow-orange/red color light spots are appearing all over the plastic perforation. The light spot appear wildly also on the electrode surface by increasing the voltage. On examining the electrode and plastic cover sheet no burn mark is observed. This proves that the plasma glow is non-thermal after an hour glow discharge. The temperature in the electrode plate recorded with a thermal couple is around 50 to about 90° C. The gas produce is mainly hydrogen with some water vapors, which condense quickly on cooling. The rate of hydrogen production is variable and energy conversion rate also fluctuated through out the test. This is suspected to cause by the recombination of H and OH, which is affected by the electrode and reactor structure and configuration.

Hydrogen can now be produced with high voltage and low current, which is again contrary to the conventional electrolysis system that small, but fast rate production is becoming possible. This has clearly demonstrated that the mechanism of producing hydrogen with plasma discharge is different from conventional water electrolysis by a number of ways. Steam and gas vapor produced due to heating of the electrodes (cathode) in short space of time are becoming an importance source of materials for plasma dissociation that also influence the productivity of hydrogen.

1.3 Experimental Procedure

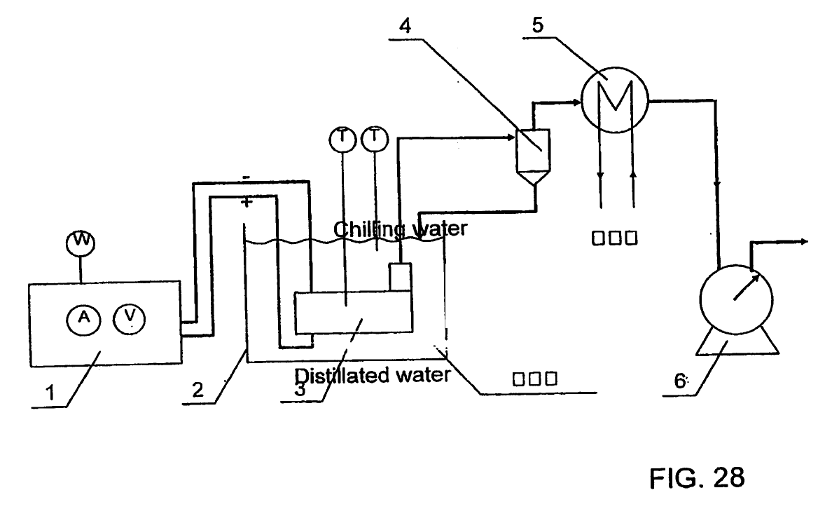

1.3.1 A flow diagram for carrying out experiments in relation to this invention is shown in FIG. 28.

The apparatus 1 comprises broadly a DC power source, liquid bath 2, reactor 3, gas & liquid separator 4, water chiller 5, gas volume measuring meter 6.

Gas was produced by electrolysis that was catalysed by the plasma. Hydrogen gas was produced at the cathode and oxygen gas at the anode.

1.3.2 Equipment Function

DC power source: provide high voltage DC.

Horizontal reactor: generation of non-thermal under liquid plasma.

Gas & liquid separator: to separate liquid from gas and return as chilled liquid.

Chiller: to condense any liquid vapor admixed in the gas and return to reactor.

Gas volume measuring meter: to measure the volume of gas flow.

1.4 Method and Operation of the Experiments

(1) The experiment is conducted in according to the occurrence of plasma discharge. Six different levels of voltage are selected to produce under liquid plasma with same reactor for the generation of hydrogen. They are: 1350V, 1450V, 1550V, 1650V, 1750V, and 1850V. Each experiment last 30 minutes and the experiment repeat three times under same set of conditions. The data obtained are than average out.

1.5 Experimental Observations

Plasma discharge at 1350V is observed to have few and limited lighting illumination on the electrode in comparing with those vigorous, steady discharging over a much larger electrode surface at voltage 1850V. The corresponding current input is also very much reduced. It has been recorded that the temperature at the cathode electrode rises with time until it reaches about 90C and gradually become steady. The color of plasma discharge appears to be orange and red Its color is greatly different from that of electric arc (plasma arc discharge) which appears to be sharp bright blue in color

Applicant also conducted experiments with the same equipment utilising the under liquid plasma to transform methanol for use in hydrogen production. Applicant found that the plasma was efficacious in producing hydrogen gas from the methanol. CO and CO2 gases were completely absent from the gas produced. This was unexpected. Without being bound thereby Applicant believes that Co and CO2 may have been absorbed by KOH which was added as a conductive agent to the electrolyte. Some oxygen gases were recorded before methanol was added to the electrolyte.

Applicant also conducted experiments with the same equipment utilising the under liquid plasma to reform hydrocarbons for hydrogen production. Applicant found that the plasma was efficacious in reforming the hydrocarbons and producing amongst other things hydrogen gas.

Applicant also conducted experiments with the same equipment utilising the under liquid plasma to treat diesel oil.

The diesel oil was emulsified in water to disperse it through the body of liquid. After being subjected to plasma conditions near the cathode a gas was produced that was smoky and resembled an exhaust gas emission that did not easily burn.

Applicant established by means of these experiments that diesel oil could be reformed and also dissociated by the in liquid plasma with this equipment.

Reformation of hydrocarbon liquid and gas fuel, and hydrogen rich compounds for hydrogen production.

Water is one of the primary source materials, which serves as carrier, conductor and confinement to the bubbles space where plasma corona and glow discharge would take place when adequate electro-potentials apply across single, or multiple electrodes pairs.

The hydrocarbon fuel methane (gas), methanol, diesel, gasoline, kerosene, ethane, natural gas, LPG gas, bio-diesel etc and hydrogen sulphur (H2S) are also good source material for hydrogen production.

The majority worldwide of hydrogen production conventionally is by high-pressure steam reformation of methane. This requires high pressure and high temperature. The production plant is large and costly to set up. Storage and delivery in association with the production are added cost for the supply of hydrogen gas.

The important of hydrogen as an alternative environmental clean fuel is well understood. The on coming of fuel cell technology demands economic and ready supply of pure hydrogen gas. To produce hydrogen with a small processor to enrich fuels for combustion engines and gas turbines will not only saving fuel consumption and also reduce polluting emission.

The proposed plasma reformation process can deal with gaseous fuel, liquid fuel. The gas fuel will be bubble into the reactor with inhibitor to slow down the upward flow of fuel gas. Since the dissociation of the hydrocarbon fuel will be mainly subjected to plasma dissociation which is similar to plasma assisted electrolysis process but with electrolytic liquid containing hydrogen rich compounds.

In the case of liquid fuel it can either form mixture with water or to be emulsified with water. The percentage of fuel in the mixing depends on the type of fuel, its conductivity, boiling point, flammability and electrochemical reaction. The reformation is mainly due to partial oxidation either with the active OH−, O−, O2, O3 created by the plasma dissociation. In the same time the hydrogen rich compound such as CH4 or CH3OH will be dissociated directly with electrons collision. Since carbon dioxide is a major by products together with some other minor gases coming out from the impurity of the fuel, they will be separated by the convention absorption method or membrane separation method.

Transformation of hydrocarbon fuel by corona and glow plasma has been attempted by passing the hydrocarbon gas such as methane, natural gas, LPG and vaporized liquid fuel sometime mixed with water vapors through the plasma reactor. They have all reported successful in producing hydrogen rich gas by corona discharge at atmospheric pressure by subjecting methane, vaporized methanol, diesel fuel with mixing of water vapor by passing through plasma gild arc reactor, wire in tube reactor and reactor proposed by MIT plasmatron and other gas phase corona streamer reactor.

The proposed under liquid plasma reactor has many advantage over the gas phase plasma reactor by being able to generate steady plasma glow discharge at a very much lower voltage from 350V to rarely 1800 V. with current in the range 100 mA to 800 mA in water.

The liquid media will also permit the application of ultrasonic waves with effect that will enhance the generation of glow plasma and thereby increase the overall transformation process. Again no external air or gas is needed to be introduced for the reaction. However, the hydrogen carbon gas such as methane, natural, LPG or hydrogen sulfurs gas can be introduced to work in conjunction and complementing with liquid fuel in the reformation process. The fuel gases will enhance plasma discharge reformation to take place without relying on gas produced by electrolysis.

Those hydro-carbon fuel molecules that come in contact with the plasma discharge will be subjected to dissociation and partial oxidation depicted in the following:
H2O+e→+OH+H++e dissociation
CH4+e→CH3+H++e direct plasma dissociation
CH4+H→CH3+H2 reacting with H radicals
CH4+H2O→CO+3H2 partial oxidation
CO+H2O→CO2+H2 water shifting
CH3OH+H2O→CO2+3H2 electrolysis and partial oxidation
H2S→S+2H without experiencing oxidation
H2S+2H2O→SO2+3H2 partial oxidation
SO2+2H2O→H2SO4+H2

Endothermic catalytic conversion of light hydro-carbon (methane to gasoline)
CnHm+nH2O→nCO+(n+m/2)H2

With heavy hydro-carbon
CH1,4+0,3H2O+0,4O2→0,9CO+0,1CO2+H2
C8H18+H2O+9/2O2→6CO+2CO2+10H2

The hydrogen gas and carbon dioxide will be collected. The CO2 will be separated by establish absorption or membrane separation method

The OH radical produced by the plasma dissociation will play an important role to oxidize the CH4 to produce CO which would further be oxidized to become CO2. The same applied to methanol CH3OH and H2S. The S is being oxidized to form SO2 and further oxidizing to become SO3 and subsequently react with H2O to produce H2SO4. This type of chemical reaction will be possible only with the encouragement of the highly chemical reactive and plasma catalytic environment. Not every CO will become CO2 and sulphur particles may be observed in the precipitation.

### REACTOR

There are number of reactors for the reformation of hydrogen rich compounds can be employed. Reactor such as wire in tube, tube in tube; single cell and multiple cell reactors; and the multi-electrodes without diaphragm separation. The tube in tube reactor and tower reactor with horizontal electrodes are suitable for treating both liquid and gas hydrocarbon and both in the same time. The anode and cathode is closely spaced with gap distant from 6 to 12 mm and are covered with dielectric gas retaining and current concentrating construction on one side or both sides of the electrode. One important aspect of the reactor is having the construction, which will accommodate the ultrasonic transducer, which would induce proper sonic cavitations uniformly, distribute through out the reacting volume. The size, shape and arrangement of the electrodes can vary but its size would be restricted by the electric power available. A small reactor electrode plate is quite adequate for good uniform discharge and high productivity. The size of reactor plate use in most of the experiments is in the range of 16 to 30 cm². It is preferable that the non-discharging electrode having an electrode area larger than the discharging electrode with the dielectric gas retaining construction. With sufficient power available both anode and cathode electrode can be functioning as plasma discharging electrodes in the same time. This is particularly favorable for the partial oxidation process.

In the case of emulsified oil water mixture it will best maintained with ultrasonic excitation which in the same time generating transient micro bubbles which will enhance the whole reactive process. Hydrocarbon gas may also introduce to the reactor to form air bubbles or trapped gas pocket for the ready formation of plasma glow discharge. Since the oily hydrocarbon fuel is highly dielectric this would require higher concentration of conducting reagent than that required for the plasma assisted water electrolysis, to maintain a suitable level of current density for the discharge to occur.

Reformation of methane gas by the under liquid non-thermal plasma is by bubbling the gas through the perforated horizontal electrodes of tower reactor or tube in tube reactor. Since the methane gas is to be oxidized by the plasma dissociated water molecule (OH−+H+) to form carbon monoxide and hydrogen gas (CH4+H2O→CO+3H2. The CO will be further oxidized to form CO2 with oxygen derived from the plasma dissociated water molecule and releasing two more hydrogen atoms (H2). The resultant gas is either H2 or CO2 with perhaps small amount of CO. The hydrogen gas will be collected with reasonable purity after the CO2 or CO is removed by absorption or membrane separation. Since the methane gas may not thoroughly reformed with one past through the reactor, it is in the first place to regulate the gas flow rate to ensure suitable resident time for the reformation or to have the methane gas recovered for the next round of reformation or to have the gas going through a series of reactor to made sure methane gas is fully utilized. The later case may not be energy efficient.

Reformation of methanol for hydrogen production can be in the first place achieved by ordinary electrolysis by partial oxidation. When CH3OH subjected to plasma discharge irradiation will become reactive with the oxidizing species and radicals dissociated from water molecules. The conventional electrolysis will also contribute to the over all production of hydrogen gas. Reformation of methanol water mixture will achieve better efficiency when plasma discharges in working in conjunction with ultrasonic excitation and cavitations. Several types of reactor can be adopted for the methanol reformation such as tower reactor with horizontal electrodes, tube in tube reactor, transverse flow reactor and etc. These types of reactor offer very active oxidizing species and hydroxyl radicals for the needed in the reformation.

Reformation of heavy oil such as diesel by under liquid plasma discharge will be with emulsified liquid. The best way to maintain a thorough emulsification of diesel fuel and water is by ultrasonic excitation. Micro droplets of diesel will be encapsulated by water. It is again observed that the conductivity of the emulsified liquid is very low as diesel oil is dielectric and current can only be conducted through the water film in between. This has rendered the need of more electrolytes added, especially when the diesel contend increases. Bubbles are not easy to be produced by electrolysis due to low current flow. It is therefore advantage to either introduce gas to the reactor from outside or to produce ultrasonic cavitations amidst the liquid volume in the same time of emulsification of water oil mixture. Tower reactor, tube in tube reactor and transverse flow reactor are all suitable for heavy hydrocarbon fuel reformation provided that adequate ultrasonic transducer is properly located to ensure effective excitation and cavitations distributed through out the liquid volume. Pulsed power supply will enhance the plasma generation and electrode heating will assist the generation of bubbles at the discharging electrode.

### REDUCTION OF METAL AND MINERAL OXIDE PROCESS

It is costly and polluting in the process of mineral refinement. To remove oxygen from the oxide is either by reacting with higher electro-positive elements, which is economically forbidden, or by exposing the metal oxide to C, CO, and hydrogen inside a high temperature furnace such as the case in iron production. The electrolysis of molten melt of Al2O3 or TiO2 to extract pure metals Al or Ti respectively consume large quantity of electricity, use of expensive refractory and electrode materials and pollutant emission which render these two useful metals very expensive and inhibit their common application.

An under liquid plasma reductive process to reduce oxide of ore or metals are proposed. The plasma discharge irradiation to the metals oxide in a highly catalytic environment will interact with the active hydrogen atoms derived from the plasma dissociation of water or methane or methanol water mixture and introduced hydrogen gas together with the assistant of ultrasonic excitation would be sufficient in many instances to dislodge the most stubborn oxide.

There is report that research is underway to extract Al from Al2O3 by electrolysis. Aluminium is electrode wined to cathode from porous Alumina anode electrode. Reduction of TiO2 and Al2O3 by hydrogen plasma discharge is also in active research elsewhere with the aim to refine these two useful metals economically.

Tube in tube reactor wire in tube reactor can be used for the reduction process. This two reactor can easily modified for continue processing the granular fine of the mineral or metal oxide. The metal oxide will be exposed to the influence of highly active hydrogen atoms and subsequently the oxygen in the metal will be removed. This would not be a problem for those electro-positive elements but would present some difficulty for oxide such as Al and Ti.

The oxygen is strongly bonded with the parent metals such as Al2O3 and TiO2 which can not be easily reduced. This rudimentary horizontal reactor serves as demonstration that metal oxide can be refined by exposing its granular fine to plasma discharge irradiation, ultrasonic excitation and in a highly reactive environment with the active hydrogen atoms. Additional hydrogen can be derived from the plasma dissociation of methane gas introduced to the reaction chamber where CO and atomic H are produced. Similarly by plasma dissociation of the methane water mixture that active hydrogen an CO2 are also produced to supplement those reductive atomic hydrogen. Hydrogen gas can also bubble into the reactor and any excess will be collected and recharging back to the reactor.

Reduction of Al2O3, TiO2, TiF3, TiO, ALCL3 will be taking place in the following manner.

Where
TiO2+4H(2H2)→Ti+2H2O
Al2O3+6H(3H2)→Al+3H2O
TiF3+3H(3/2H2)→Ti+3HF

The alternative is to have
TiO2+H2SO4→TiOSO4+H2O
TiOSO4+2H→TiO+H2SO4
or TiO+2H→Ti+H2O
and
TiO2+4HCl→TiCl4+2H2O
TiCl4+4H→Ti+4HCl
where TiCl4 is ionic and is soluble in water

The above reaction is under influence of non-thermal plasma that the oxide of ores or metal is subjected to a highly catalytic environment and come in contact with the reactive atomic hydrogen whereby the oxygen will be taken out. To enhance the matter further the whole reaction process is also subjected to the sonic excitation. The colloidal suspension of the fine granular oxide will collide with each other that at the point of impact temperature would rise over 1500 to 3000° C. and local melting is reported. The high temperature and pressure of collapsing sonic bubble will work in conjunction with the plasma glow discharge irradiating the oxide particles with atomic hydrogen with localized high temperature due to collision and cavitations implosion which in the end remove the oxygen. The refine metals will be in powdery form down to nano size.

The other method of extracting and refining metals from its oxide is to subject the ionic solution of the metal such as AlCl3 to a electrolysis process which is reported to have achieved efficiency of 3 KW h/kg of Al. The whole process can be further improved with the plasma electroplating technique with the proposed under liquid glow plasma discharge. The Al will be deposited on the cathode electrode. Part of chlorine gas will comes out from the anode side and many will react with the active hydrogen to form HCl.

The fine granular metal oxide is placed inside a horizontal reactor on top of cathode electrode. A close matrix separator membrane to prevent the metal oxide to cross over separates the anode electrode above and below the cathode. The whole reactor is submerged inside an ultrasonic bath. Ultrasonic waves will penetrate the membrane separator to cause the granular metal oxide in colloidal suspension. The oxide will subjected to the under liquid plasma glow discharge irradiation and atomic hydrogen reduction. The percentage of metal oxide being reduced after a period of time is evaluated. Metal oxide of TiO2 will be put to test. Methane water mixture will be employed as the liquid media which will produce larger amount of active atomic hydrogen serving as reduction agents.

### DECONTAMINATION OF LIQUID

The problem of pollution is a major issue affecting every living being in this planet earth. A lot of effort has been spending by Governments, universities and private enterprises seeking comprehensive process to deal with vast variety of pollution. Polluting gas emission from industries and motor vehicles produce large quantity of CO2 causing global warming; NOx, VOC, and particulates causes cancer and smog; SO2 causes acid rain. Decontamination of gases discharge from industries at time is costly to neutralize and remove which urgently need a comprehensive and economic treatment process to reduce the overall production cost. Water contamination is another major issue. It contaminate fresh water source unfitted for human consumption and sea near shore killing marine live. Government in the world is passing stringent law setting pollution standard, which demands development efficient and economic ways or process in controlling and decontaminating pollutions. The present proposed invention is put forward as a versatile process, which can treat a variety of contaminant in separate or together.

Corona discharge and glow plasma discharge as non-equilibrium plasma has been developed for applications in the decontamination a wide range of noxious chemical compounds and recalcitrant chlorinated organic compounds such as dichloro-ethane, pentachlorophenol, perchloroethylene, chlorom, carbon tectrachloride, organochlorine presiticides, endocrine disrupter, dioxin and etc. It is also capable to sterilize tough microbial, bacteria and biological contaminants present in ground water such as cryptosporidia parvum. Noxious gas emission such as NOx and SOx can also be neutralized by passing them through the wet reactor, which includes the removal of particulates with the polluted emission. This is mainly due to the ability of plasma in creating a very reactive catalytic environment for those compound, which would normally very stable and inactive, to be reduced, oxidized or neutralized by reacting with the OH* radicals, atomic hydrogen H+ and other oxidative species such as O−, O2, O3, H2O2 etc. present and is reported of having high efficiency especially in dealing with diluted contaminant.

Microbial and bacteria is removed by both oxidations when come in contact with the oxidative species such as O3, O2−, O−, H2O2, OH*. In the same time they are subjected to the electromechanical stretching of the cell wall, which weakens its oxidative resistance. Especially, with the application of ultrasonic cavitations implosion and shock waves created by pulse power are incorporated in the reactive process. Again report of over 99% sterilization is not uncommon.

At the present most of the treatment work is conducting in gases environment, by spraying or vaporizing the contaminated liquid over the plasma discharging electrodes, or to produce plasma discharge irradiating over liquid surface which contains the undesirable contaminants, or by passing the polluted gas through dry reactor which sometime mixed with water vapor or using plasma torch irradiating the pollute object.

Surface water contact plasma glow discharge system has also been developed as an decontamination process in the name of Plasmate. Under water plasma by pulsed high voltage electric discharge with high current input to dissociate the water to produce H and OH* radicals to treat bacterial and microbial decontamination has also been reported with success.

The proposed under liquid plasma is a low energy consumption system, which produce steady plasma by utilizing the present of bubbles. The voltage require in dealing with wide range of liquid of having uncontrollable electrolytic properties is ranging from 350V to 3000V and current density ranging from 1 to 2 Amp/cm2. It is not only producing the highly reactive environment with supply of oxidative radicals and reductive atomic hydrogen spreading over large volume of liquid making it highly effective as a decontaminate process which is also economic and easy to operate.

The under liquid plasma is having the advantage to decontaminate several pollutants in the same time and is also having a very active gas and liquid interaction rendering it highly effective as treatment process. Liquid waste containing harmful chemical, bacteria, microbial, heavy metals, noxious gas emission, polluted air and odor can be treated in the same reactor simultaneously.

Recalcitrant organic chlorinated organics materials in water, which include dichloromethane, pentachlorophenol, chloroform and carbon tetrachloride, will either be oxidized or reduced degraded to CO2 and chlorine. While the pathogens in drinking water such as cryptosporidia with thick phospholipids wall protecting the trophs is in the first place being stretched and weaken and subsequently break down by the oxidizing species. Some of the oxidative species such as OH radicals, O−, O2−, and O3 are present in quantity and are more active than chlorine and other mild oxidants. It has the advantage that no chemical is needed as oxidation agent, which sometime result a secondary pollution.

Heavy metals in dilute solution can be extracted or removed through a simple electrolysis process by turning the metal to hydroxide which could than be remove by filter. In the case of soluble metal ions it can also be extracted by deposition on to cathode electrode, which can further be facilitated by the plasma electroplating process owned by the inventor using the same under liquid bubble plasma process.

The treatment of NO, SO2 and particulates is to pass the polluted gas through the reactor where the particulate will be removed and the NO is either oxidized to become NO2 and NO3 by O−, or O3. It can also be reduced to N by the active hydrogen. NO3 will react with water to become nitric acid. NO2 is considered not a noxious gas. SO2 reacting with O3 or oxygen radical to form SO3 can easily oxidize SO2, which than react with water to become H2SO4. When the said gas is introduced to the reactor it can be utilized as a gas bubble for plasma discharge especially when this gas bubble is collected or retain near the electrodes.

The effectiveness of non-thermal plasma discharge in treating carcinogen organic compounds and polluted gases are well established. Removal or reduce the amount heavy metals, arsenic and mercury to an acceptable safe level in low concentration from water have been successfully carried out by simple electrolysis process. The extraction efficiency is further improved with the present of under liquid plasma discharge where some of them will be readily react with the OH radicals to become metal hydroxide or to be deposited by the very active plasma electroplating (deposition) which has been adequately proven.

Further experiments in this area are unnecessary. Adequate information can be drawn upon from many research work already been carried out. Concentrated effort has been spend to search for a better way to generating steady plasma glow discharge under liquid by utilizing the bubbles which will enable the manufacturing of simple and economic reactor requiring low power input that work well in treating a wide scope of contaminants.

Sterilization of drinking water in municipal scale can be simplified by adopting the under liquid plasma discharge which will effectively neutralize and degrade carcinogen organic compounds in the water by in the first place create the dissociate and active catalytic environment which encourage the breakdown of the inert chemicals and in the same time subject it to the active reductive and oxidative radicals. The heavy metals dissolved in the water will also be removed or reduced in the same time through the plasma electrolysis and electroplating as described previously. The biological contaminants will be sterilized by the highly oxidative environment existed during the glow discharge. The effectiveness of combine treatment of portable water fit for human consumption is further enhanced by the adoption of ultrasonic cavitations and shock wave with pulsed power supply.

The entire sterilization process does not require any added chemicals such as ozone, chlorine and any electrolytic additive. The impurity in the pretreated liquid will be adequate to serve as conductor for the under water plasma discharge to take place. Any excessive ozone, which has not been used up in the oxidation process during the plasma discharge, will be easily neutralized by present of active hydrogen atoms. Hydroxyl radicals (OH) are one of the most aggressive oxidizing agents, which are produced in quantity that will do most of the useful work. There will be no chlorine remnant left in the water, as it is unnecessary.

The under liquid plasma technique will be useful in food industries for low temperature sterilization and removal of odour. The same may also find its use in paper industry in fragmentation and de-lignifications the fluidised pulps, treating the highly polluted discharge, and treating fabrics and dyes in textiles industries.

There are several types of reactors can be employed in the decontamination process. The separation membrane diaphragm in the wire in tube and tube in tube reactor is no longer required. Other reactor such as transverse flow reactor and tower reactor can all be adopted.

The reactor can be arrange in such way that the plasma discharge occurs either on the cathode or anode and in both electrode as long as good gas trapping cover is provided on the electrode. Since many of the decontamination action is relying on the present of strong oxidation agents such as hydroxyl radicals, atomic oxygen, ozone, singlet oxygen and hydroperoxyl radicals, plasma discharge on the side of anode electrode enhanced with the gas retaining cover will cause the formation of said species represented by the following equations:
H2O+e→OH+H+e dissociation
H2O+e→+H2O₊+2e ionization
H2O₊+H2O→H3O₊+OH dissociation
O2+e→O2*+e excitation
O2+e→+2O+e dissociation
O2+e→O−+O dissociation
O2+O→O3 association
OH+OH→H2O2 association

In some chemical contaminants can only be broken down by reduction with active atomic hydrogen, which would require of plasma discharge in the cathode electrode. In the tower reactor (FIG. 7) and transverse flow reactor (FIG. 6) it is possible of having the gas retaining cover on one side of electrode facing the side of the opposite electrode with the gas retaining covers, so that alternating zone of oxidation and reduction are created in the reactors to deal with a variety of contaminants.

Production of hydrogen by plasma dissociation of water molecules is the result of electron collision, which is different from the conventional electrolysis, which separates the dipole water molecules by the electro-induction. They also have different sets of requirements to dissociate water molecules for the production of hydrogen.

| | Plasma glow discharge under |
|---|---|
| | water, according to the present |
| Conventional electrolysis | invention |
| 1. Low voltage and high current density | High voltage and relatively low |
| | current density |
| 2. High concentration of electrolyte (up | Low concentration electrolyte |
| to 25% KOH) | (0.01% KOH) low electrolytic |
| | requirement. |
| 3. Avoid bubble attachment to the | Bubbles smothering the |
| electrodes | electrodes is welcome to create |
| | dielectric barrier. |
| 4. Electrode space distance is not | Electrode space distance has to |
| restricted. | keep close as far as possible. |
| 5. Water molecules is split by induction | Water molecules is dissociated |
| | by electron collision. |
| 6. Large production unit is required for | Small production unit |
| efficiency and productivity. | favor decentralization of |
| | production. |

The reactors and gas trapping and retaining structures enclosing the electrode is made of perplex plastic. No sign of burning is observed in the plastic covering plate directly over the discharging electrode is observed and the light emission observed is orange/red color (burning of hydrogen) which is distinctively different from the plasma arc which is bright blue color when the voltage is brought beyond the glow discharge voltage level. Burn mark will be observed after plasma arc discharge. This proves that the o plasma glow discharge with orange yellow color is non-thermal.

Applicant also conducted experiments with the same equipment utilising the under liquid plasma to sterilise mulberry juice. Applicant found that the plasma was efficacious in reducing the bacterial count and the mould colony count in the juice. After 40 minutes the counts of both bacteria and mould had been reduced substantially to less than 100 per ml.

This demonstrates that the invention could be used to sterilise potable water, waste water, food, and liquid food and others.

### CONCLUSION

A further advantage of the method described above is that plasma can be generated with relative ease within bubbles in the aqueous medium. It does not require excessive amounts of energy and also can be done at atmospheric pressure. It certainly does not require a vacuum chamber.

A further advantage of the invention is that it provides a method of treating aqueous waste that removed components that cannot be neutralised or otherwise rendered unharmful by the addition of chemicals to the liquid.

It will of course be realised that the above has been given only by way of illustrative example of the invention and that all such modifications and variations thereto as would be apparent to persons skilled in the art are deemed to fall within the broad scope and ambit of the invention as herein set forth.

1. A method for generating and utilizing a non thermal plasma generated in the manner of glow discharge or corona discharge the method comprising:
providing a reactor containing a body of electrically conductive aqueous liquid with at least two electrodes comprising a cathode and an anode projecting into the aqueous liquid and applying a voltage across the electrodes to cause a current to flow through the liquid between the electrodes;
causing a stream of bubbles to be generated adjacent to at least one of the cathode and anode electrode, the bubbles acting as a gaseous dielectric barrier to increase the voltage across the electrodes; and
increasing the voltage applied across the electrodes to the point where dielectric breakdown of gas within the bubbles occurs leading to glow discharge or corona discharge but not arc discharge within at least some of the bubbles and the formation of a non thermal plasma within the bubbles causing ionization and dissociation of gaseous and/or vapor molecules within the bubbles and the liquid adjacent to the bubbles, which in turn generates ionized species; oxidation species; reduction species; free radicals and/or neutral species and it also thereby provides a highly reactive plasma catalytic environment within which materials can be transformed by oxidation or reduction processes, the method being used in a variety of applications to encourage chemical reactions to occur to transform or alter material.

2. A method according to claim 1, wherein the applications include production of hydrogen gas by plasma assisted electrolysis of water; production of hydrogen gas by transforming or reforming hydrogen rich compounds including hydrocarbons by undergoing plasma dissociation, oxidation and water shifting reaction; refining ionic soluble metal compounds and removal of oxygen from metal or mineral oxide by plasma assisted reduction with reduction species including H⁺ and/or CO; decontamination of noxious chemicals in liquid or gas, sterilization of pathological and/or biological matter contained in liquid or gas, and extraction and removal of heavy metals contained in liquid or gas by oxidation and at least some by reduction.

3. A method according to claim 1, wherein one said applications comprises the production of nano particles and the enhancement of material surfaces through reduction.

4. A method according to claim 1, wherein said stream of bubbles is generated within the liquid as distinct from gas introduced externally to the liquid to form said gaseous dielectric barrier around the adjacent electrode, which enables the voltage across the electrodes to be raised by increasing the electric current until dielectric breakdown occurs transforming gaseous/vapor molecules in the bubble into a corona and/or glow discharge plasma.

5. A method according to claim 1, whereby the bubbles are generated by chemical, electrochemical reaction, electrolysis, ebullition by heating at the electrode, ultrasonic cavitations and/or laser heating.

6. A method according to claim 1, wherein the bubbles subjected to plasma transformation include hydrogen gas at the cathode, and oxygen gas at the anode and some other gases or vapors released and diffused inside the bubble due to chemical, electrochemical reaction, electrolysis and heating in according to the materials and composition of the liquid of which water is a important components.

7. A method according to claim 6, wherein the water/liquid vapors, hydrogen and oxygen is transformed by the plasma into free radicals, and reductive and oxidative species that include one or more of the following: H⁺, OH⁻, O⁻, O₂, O₃ and H₂O₂.

8. A method according to claim 1, water is a major components of the liquid which acts as the carrier to those materials to undergo transformation and reaction; and a economic source of materials to produce hydrogen, oxygen and active reduction and oxidation species such as H+, O⁻, O₂, O₃, OH−, H₂O₂ and etc needed in various applications.

9. A method according to claim 1, including enhancing the formation of plasma within the bubbles by one or more of the following: ultrasonic waves causing cavitations of the aqueous liquid, pulsed power supply, RF power, microwave radiation of the liquid, application of a magnetron field to the liquid, and application of laser to the liquid.

10. A method according to claim 1, wherein the aqueous liquid is in the form of a single phase liquid with compounds or ions in solution, a colloid in which solid fine particles and biological matters are suspended in the aqueous liquid, an emulsion of a water insoluble phase dispersed within the aqueous liquid or vice versa, or a foam liquid enclosing gas spaces within the aqueous liquid.

11. A method according to claim 1, wherein the voltage that is applied across the electrodes to effect the corona and glow discharge is 0.35 kV-3 kV and the electric current passing between the electrodes during the discharge is 50 mA to 900 mA or with a current density rarely exceed 3 Amp/cm2.

12. A method according to claim 1, wherein the plasma formation operates at atmospheric pressure and gas pressure higher or lower than one atmospheric pressure is permitted to favor and meet the need of certain applications; temperature of liquid in the initiation of plasma formation is generally at room temperature and higher temperature is permitted.

13. A method according to claim 1, wherein one electrode has a smaller conductive surface area than the other electrode thereby to achieve a higher current density at that electrode.

14. A method according to claim 13, wherein one electrode is partially covered or coated with a dielectric material whereby to reduce the surface area of the electrode that is electrically conductive to achieve a higher current density at that electrode.

15. A method according to claim 13, wherein the bubbles and the glow or corona discharge can be generated at either the cathode or anode, and the discharge is generated at the cathode or anode as the case may be by that electrode being formed with a said smaller electrically conductive surface area thereby to result in a higher current density at that particular electrode which leads to the discharge occurring at that electrode and plasma discharge in both electrodes simultaneously is achieved by selecting suitable ratio of electrode conducting surface and increase of voltage application.

16. A method according to claim 1, including means for substantially confining the bubbles to a region proximate to the electrode comprising a liquid and gas permeable barrier spaced laterally away from the electrode.

17. A method according to claim 16, wherein the barrier is a honeycomb or perforated or porous slab or a foam mattress extending across the electrode spaced away from the electrode, or a plurality of layers of fine stainless steel mesh extending across the electrode spaced away from the electrode.

18. A method according to claim 1, wherein the reactor includes a gas collector for collecting gas such as hydrogen and oxygen gas that is generated adjacent at least one electrode enabling it to be drawn off separate from the liquid.

19. A method according to claim 1, wherein the reactor includes an ion conductive membrane interposed between the cathode and the anode to define anode and cathode compartments in the reactor, and keep gases generated at respectively the anode and cathode separate from each other while still permitting current to flow between the electrodes and the compartmented reactor or half cell enables oxidation or reduction reaction process to take place separately at their respected compartment.

20. A method according to claim 1, wherein the aqueous liquid further includes additional source material which is altered and/or dissociated by the plasma in the bubbles to generate further oxidizing and/or reducing agents in addition to those generated by hydrogen and oxygen.

21. A method according to claim 20, wherein the additional source material is dissolved in the aqueous liquid or suspended in a colloidal suspension in the aqueous liquid, or the material is dispersed through the aqueous liquid as a fine solid.

22. A method according to claim 1, wherein the electrode is comprised of materials that are electrical conductors, and are resistant to thermal and chemical erosion and the materials include stainless steel, tungsten, graphite, aluminum, zinc, silver, titanium, platinum, copper, palladium and other metal alloys having the required properties.

23. A method according to claim 1, wherein each electrode is in the shape of a plate, a wire, a rod, a mesh, a perforated plate, a sponged/honeycomb slab, a pipe, a spiral rod or a cylinder.

24. A method according to claim 23, wherein the cathode and anode are configured/arranged in the form of plate to plate, plate to wire or rod, rod to rod, wire/rod in a cylinder; or tube in tube.

25. A method according to claim 2, wherein the reformation of hydrogen rich compounds or hydrocarbons to produce hydrogen is by subjecting it to plasma dissociation, ionization and then catalyzed by one or more of the oxidizing agents OH⁻, O⁻, O₂, O₃ generated in the plasma to produce hydrogen gas and hydrogen compounds and carbon and oxygen compounds, and wherein the carbon and oxygen compounds include carbon monoxide and the carbon monoxide undergoes a water shift reaction with water molecules to produce further hydrogen gas and carbon dioxide.

26. A method according to claim 25, wherein the hydrocarbon is in the form of hydrocarbon gas which is bubbled into the aqueous liquid below the discharging cathode and /or anode electrodes such that it rises through the liquid in proximity to the discharging electrode and subjected to the influence of plasma and react with the present of oxidation species to be reformed.

27. A method according to claim 26, wherein the hydrocarbon gas contains one or more of the following: methane gas, ethane gas, LPG, butane gas, and natural gas.

28. A method according to claim 25, wherein the hydrocarbon is in the form of a hydrocarbon liquid which is either dissolved in the aqueous liquid or dispersed in the aqueous liquid as a colloidal suspension.

29. A method according to claim 28, wherein the hydrocarbon liquid is one or more of the following: ethanol, methanol, glucose solution, diesel, gasoline, kerosene, or bio-diesel, vegetable oil and animal fat.

30. A method according to claim 2, wherein the liquid or gas includes H₂S which is being dissociated and oxidized by oxidizing agents to yield, sulfur, sulfur dioxide and/or sulfuric acid and hydrogen gas.

31. A method according to claim 2, wherein the mineral oxide is a non-metal oxide such as that of S, C and Si and the mineral oxide is reduced by a reductive hydrogen species.

32. A method according to claim 2, wherein the soluble ionic metal compounds and metal or mineral oxide is a metal such as that of Al, Cu, Zn, Fe ,Ti, Ag, Au, Mo, rare earth metals and etc; and the ionic metal compounds and metal or mineral oxide is reduced by a reductive hydrogen species and/or carbon monoxide.

33. A method according to claim 32, wherein the soluble ionic metal compounds such as chloride or fluoride of titanium or aluminum, and etc is introduced to the aqueous liquid, to form an ionic solution which is dissolved within the liquid or mineral or metal oxide to form a suspension of finely divided granules or particles within the liquid.

34. A method according to claim 2, wherein the reductive hydrogen species are provided by both the dissociation of water vapors and ionization of hydrogen gas and the reformation hydrocarbon materials such as methane gas, methanol, ethanol by the plasma, thereby to provide a strong reducing agents such as H⁺ and/or carbon monoxide reacting in an active catalytic plasma environment to achieve the reduction to refine ionic metal compounds and metal or mineral oxide to metal.

35. A method according to claim 2, wherein the noxious chemical compounds include chlorinated organic compounds including one or more of the following: dichloroethane, pentachlorophenol, perchloroethylene, chloroma, carbon tetrachloride, organochlorine pesticides, endocrine disrupter, and dioxin which is to be subjected to oxidation and some by reduction in a plasma catalytic environments to become neutralized and rendered harmless.

36. A method according to claim 2, wherein the heavy metals are converted to metal oxide or hydroxide by plasma assisted oxidation which then deposits out as a solid precipitate, and wherein the metal hydroxide precipitate can be subsequently removed by filtration.

37. A method according to claim 2, wherein the heavy metals include one or more of the following: Hg, Cr, Pb, Cu, Ni, Zn and etc.

38. A method according to claim 2, wherein the pathogens include microbial, bacterial and biological contaminants and particularly cryptosporidia parvum.

39. A method according to claim 2, wherein the aqueous liquid further includes additives to increase the electrical conductivity of the liquid by increasing the number of ions in the liquid.

40. A method according to claim 1, wherein the additives include the following: KCl, MgCl₂, NaOH, Na₂CO₃, K₂CO₃, H₂SO₄, and HCl.

41. A method according to claim 2, the noxious chemicals or materials is a gas such as NOₓ, SOₓ, odor gas, H₂S and chlorinated compounds whereby such gas is allowed to pass through the discharging electrodes in the form of bubbles and subject it to plasma influence and undergo oxidation reaction in an active catalytic environment to render such gases to be transformed and become less harm.

42. A method according to claim 1, wherein the liquid is water and hydrogen gas is produced at the cathode and oxygen gas produced at the anode on application of electricity which is further assisted by the formation of plasma that maintain the flow of current across the electrodes by electric break down the bubble barrier to continue production of gas and further additional gas production as the result of plasma dissociation of water molecules in the bubbles and those aligning the bubble wall in producing H⁺ and OH⁻ and then to H₂ and O₂.

43. A method according to claim 42, wherein a higher input electric energy with higher voltage for the formation of plasma is assisting electrolysis of water for the production of hydrogen resulting higher production rate and thus a small electrolysis reactor and bath is required.

44. A method according to claim 42, wherein to prevent recombination of H⁺ and OH− the electrode gap spacing to keep suitably close to allow rapid migration of OH⁻ to anode and H⁺ to cathode and application of magnetic or magnetron field on the side of one or both electrodes to attract H⁺ to cathode electrode and repel OH⁻ to anode and vice versa.

45. A method according to claim 1, wherein the electrode gap spacing is to space close to provide a high electric field strength and yet to keep at a suitable distance to avoid formation of arc discharge to prevent damage to the electrodes and excessive consumption of electricity; and the practical electrode gap spacing is ranging from 6 to 20 mm.

46. A method according to claim 1, wherein during the formation of plasma in a liquid, heat is generated that raise the bath temperature from 50 to 90° C. or higher, and the heat produced is to be recovered as by product of such plasma action by convention heat exchange method.

47. A method according to claim 1, wherein the electrodes are vertically positioned or horizontally positioned in pairs or in multiple pairs with cathode and anode placed in parallel array or alternatively.

48. A method according to claim 3, wherein the refined metals from metal oxide after removal its oxygen, metals extracted from its ionic compounds and metal hydroxide or oxide precipitated from a liquid is at least some of them of nano size in a process of rapid but gradually restructuring and transformation of the materials at sub molecular and atomic level in a low temperature conditions.

49. A method according to claim 2, wherein decontamination of noxious chemicals, sterilization of pathological and biological matters and extraction of heavy metals from a fluid is carried out spontaneously whereby it is particularly suitable for treatment of municipal water for public consumption or treatment of waste disposal with multiple contaminants.

50. A method of claim 2, wherein the decontamination or sterilization process of biological and pathological materials in a fluid/ liquid is conducted at a low temperature of about 50° C. thereby render this process particularly suitable for treating fluidized food without affecting its original food quality and taste.

51. A method of claim 1, wherein chemical reaction between different materials, chemical compound in liquid or gases present in the bath reactor is actively encouraged which would otherwise be inert through plasma action in ionization and dissociation process and provision of oxidation and reduction species.

52. A method of claim 9, wherein ultrasonic waves is applied to the bath liquid to maintain the colloidal suspension of solid particulate in a fluid or emulsification of insoluble liquid and at the same time utilizing the physical and mechanical properties of sonic cavitations which supplements reaction in the bath by creating localized super high temperature, extreme high pressure and excitation upon the collapsing phase of cavities that enhance the transformation of materials in oxidation and reduction process in an active plasma catalytic environment.

53. Apparatus for generating and utilizing a non thermal plasma in the form of glow discharge or corona discharge in a liquid, the apparatus comprising:
a reactor defining a bath for receiving a body of electrically conductive liquid having at least two electrodes comprising a cathode and an anode that in use project into the liquid and apply a voltage across the electrodes to cause a current to flow between the electrodes;
means for generating a stream of bubbles in the liquid adjacent to at least one of the cathode and anode, the bubbles acting as a gaseous dielectric barrier to the flow of current between the electrodes; and
an electrical supply means for applying a voltage across the electrodes and increasing the voltage up to the point where dielectric breakdown of gas within the bubbles occurs leading to glow discharge or corona discharge but not arc discharge within at least some of the bubbles, and the formation of a non-thermal plasma within the bubbles causing ionization and dissociation of gaseous and/or vapor molecules within the bubbles and the liquid adjacent to the bubbles, which in turn generates a highly reactive plasma catalytic environment containing a number of reactive species within which materials can be transformed by oxidation or reduction processes.

54. Apparatus according to claim 53, wherein the means for generating a stream of bubbles comprise at least one said electrode evolving bubbles due to electrolysis.

55. Apparatus according to claim 53, wherein the means for generating a stream of bubbles comprises means for generating the bubbles by chemical reaction, electrochemical reaction, electrolysis, ebullition by heating at the electrode, ultrasonic cavitations and/or laser heating.

56. Apparatus according to claim 53, wherein the means for generating a stream of bubbles includes an ultrasonic generator for transmitting ultrasonic waves into the liquid.

57. Apparatus according to claim 53, further including means for assisting the formation of plasma within the reactor comprising;
a pulsed or steady power supply, a magnetron field, ultrasonic radiation, a hot filament capable of electron emission, laser radiation, radio radiation, and/or microwave radiation whereby to reduce the energy input required to cause glow or corona discharge to be formed in the bubbles.

58. Apparatus according to claim 53, wherein the means for applying a potential difference across the electrodes comprises an electrical power supply capable of applying a potential difference of up to 3000 volts.

59. Apparatus according to claim 53, wherein one electrode has a smaller conductive area than the other electrode whereby to cause a higher current density to flow from said conductive surface area at said electrode.

60. Apparatus according to claim 59, wherein one electrode is partially covered or coated with a dielectric material whereby to reduce the surface area of said one electrode that is electrically conductive to achieve a higher current density at that electrode.

61. Apparatus according to claim 53, further including bubble confining means in the form of a liquid and gas permeable barrier spaced laterally away from at least one electrode for substantially confining the bubbles to a region proximate to the electrodes.

62. Apparatus according to claim 61, wherein said liquid and gas permeable barrier is a honeycomb, a perforated or porous slab, a foam mattress, or a plurality of laser fine stainless steel mesh extending across the electrode spaced away from the electrode.

63. Apparatus according to claim 53, wherein the reactor includes a gas collector adjacent at least one of said electrodes for collecting a gas such as hydrogen or oxygen that is generated at said electrode enabling it to be drawing off as a gas.

64. Apparatus according to claim 53, wherein the reactor includes an ion conductive membrane interposed between the cathode and the anode to define anode and cathode compartments within the reactor whereby to keep gases generated at respectively the anode and cathode separate from each other while still permitting current to flow between the electrodes enabling oxidation or reduction reactions to take place in their respective compartments.

65. Apparatus according to claim 53, wherein each electrode is comprised of an electrical conductor selected from the group of: stainless steel, tungsten, graphite, aluminum, zinc, silver, titanium, platinum, copper, and palladium.

66. Apparatus according to claim 65, wherein each electrode is in the shape of a plate, a wire, a rod, a mesh, a sponge or honeycomb slab, a pipe, a spiral rod or a cylinder.

67. Apparatus according to claim 53, wherein the spacing between the cathode and the electrode is in the range of 6 mm to 20 mm.
